(19) United States
(12) Patent Application Publication
(10) Pub. No.: US 2013/0066897 A1
(43) Pub. Date: Mar. 14, 2013

(54) User Interfaces for Life Cycle Inventory and Assessment Data

(71) Applicants: Michael Victor Ehrenberg, Seattle, WA (US); Neil Gregory Huizenga, Bellevue, WA (US); Daniel Christian Brown, Bellevue, WA (US)

(72) Inventors: Michael Victor Ehrenberg, Seattle, WA (US); Neil Gregory Huizenga, Bellevue, WA (US); Daniel Christian Brown, Bellevue, WA (US)

(73) Assignee: MICROSOFT CORPORATION, Redmond, WA (US)

(21) Appl. No.: 13/228,381

(22) Filed: Sep. 8, 2011

(51) Int. Cl. G06F 17/30

(52) U.S. Cl. 707/769; 707/E17.014

(57) ABSTRACT

User interfaces are provided for submitting and obtaining life cycle inventory and assessment data. Suppliers of goods and/or services may provide life cycle inventory data via a user interface component through a secure framework to a life cycle inventory and assessment data hub for validation and auditing. Access to the life cycle inventory and assessment data hub may be through a web services platform for allowing the suppliers secured access to the data and functionality of the data hub. Suppliers and end users may access the data hub via the web services platform using one or more LCI/LCIA user interfaces for obtaining validated and audited life cycle inventory data and for obtaining generated and/or aggregated life cycle assessment scores for one or more goods and/or services.

### BACKGROUND

Systems and methods have been developed for providing information to consumers and customers about various components of a good or service, for example, the ingredients in a food item. Such information may provide amounts of various components, chemical names for the components and calories associated with the consumption of such components. Unfortunately, information about the environmental and/or social impacts of goods and/or services is not provided. Concerns about environmental and social responsibility in product manufacturing, distribution and use are driving the need to provide information about products to consumers at all phases of a product's life cycle (from growth/manufacturing to disposal) to allow consumers to know whether a given product was produced or used in a responsible manner or to allow consumers to know the environmental and/or social impact of a given product for comparing the product against other products. For example, a purchaser of an article of clothing may believe the article of clothing was manufactured in an environmentally and socially responsible manner, but in reality, a portion of the manufacturing life cycle, for example, cotton growth, may have been produced using a variety of fertilizers and pesticides the purchaser may find unacceptable. Moreover, the cotton may have been harvested in a manner that did not meet acceptable labor standards (for example, use of child labor).

Information users desiring such information may exist at all phases of production or use, for example, downstream component purchasers, retailers, end users, or even disposers of a depleted or used product. In addition to a need for the availability of such information, users need an efficient means for accessing such information to assist them in making informed decisions with respect to purchase, use and disposal of a variety of goods and/or services.

It is with respect to these and other considerations that the present invention has been made.

### SUMMARY

Embodiments of the present invention solve the above and other problems by providing user interfaces for submitting and obtaining life cycle inventory and assessment data. Suppliers of goods and/or services may provide life cycle inventory data via a user interface component through a secure framework to a life cycle inventory and assessment data hub where the life cycle inventory data may be validated and audited to determine whether the received data is appropriate for use in the generation of a life cycle impact assessment and score for an associated good or service. Access to the life cycle inventory and assessment data hub may be through a web services platform for allowing the suppliers secured access to the data and functionality of the data hub. Suppliers and end users may access the data hub via the web services platform using one or more LCI/LCIA user interfaces for obtaining validated and audited life cycle inventory data and for obtaining generated and/or aggregated life cycle impact assessments and scores for one or more goods and/or services. Access by suppliers and/or end users may be made from a variety of computing devices, including stationary, mobile and kiosk-based computing devices.

The details of one or more embodiments are set forth in the accompanying drawings and descriptions below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 is a simplified block diagram illustrating a life cycle of one or more goods and/or services from production through consumption and/or disposal.

FIGS. 2A and 2B are simplified block diagrams of a data hub for receiving and processing life cycle inventory data.

FIG. 3 is a simplified block diagram of a life cycle inventory input/output security framework.

FIG. 4 is a simplified block diagram showing two data input documents.

FIG. 5 is a simplified block diagram illustrating application and management of metadata associated with life cycle inventory data items.

FIG. 6 is a simplified block diagram of a system architecture for parsing stored metadata associated with life cycle inventory data items and for comparing stored metadata with one or more data management parameters.

FIG. 7 is a simplified block diagram illustrating a system architecture for aggregating life cycle inventory data and for generating a life cycle assessment score for a given good and/or service.

FIG. 8 is a simplified block diagram illustrating a system architecture for providing life cycle assessment scoring information to requesting parties.

FIG. 9 is a flowchart illustrating a method for aggregating life cycle inventory data and for generating life cycle assessment scoring for a good and/or service.

FIG. 10 is a simplified block diagram illustrating a system architecture for allowing one or more providers or users of LCI and LCIA data to interact with LCI/LCIA data and LCI/LCIA data processing functionality via a web services platform.

FIG. 11 is a simplified block diagram of a web-based interface with which a supplier or consumer may provide LCI and LCIA data and with which a supplier or consumer may request LCI and LCIA data.

FIG. 12 is a simplified block diagram illustrating a web-based interface showing an LCIA product list interface.

FIG. 13 is a simplified block diagram of a web-based interface showing a structure data template for receiving LCI data items.

FIG. 14 is a simplified block diagram illustrating a web-based interface showing a unit process model-based template for submitting LCI data.

FIG. 15 is a simplified block diagram of a web-based interface with which a supplier or consumer may request LCI and LCIA data.

FIG. 16 is a simplified block diagram illustrating a label affixed to an example article of clothing and showing information contained on the label including life cycle assessment scoring for the example article of clothing.

FIG. 17 is a simplified block diagram of a computing device with which embodiments of the present invention may be practiced.

FIGS. 18A and 18B are simplified block diagrams of a mobile computing device with which embodiments of the present invention may be practiced.

FIG. 19 is a simplified block diagram of a distributed computing system in which embodiments of the present invention may be practiced.

### DETAILED DESCRIPTION

The following detailed description refers to the accompanying drawings. Wherever possible, the same reference numbers are used in the drawing and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

As briefly described above, embodiments of the present invention solve the above and other problems by providing user interfaces for submitting and obtaining life cycle inventory and assessment data. Suppliers of goods and/or services may provide life cycle inventory data via a user interface component through a secure framework to a life cycle inventory and assessment data hub where the life cycle inventory data may be validated and audited to determine whether the received data is appropriate for use in the generation of a life cycle assessment score for an associated good or service. Access to the life cycle inventory and assessment data hub may be through a web services platform for allowing the suppliers secured access to the data and functionality of the data hub.

According to embodiments, life cycle inventory data are provided by suppliers of goods and/or services so that the data may be validated and audited for determining whether the data is correct data for the associated data type and for determining whether the provided data is accurate. Validated and audited life cycle inventory data may be stored for subsequent retrieval and use by other suppliers of goods and/or services for information needed in their provision of goods and/or services. For example, a crops grower who desires to learn about fuel types and fuel usages may request life cycle inventory data for fuel types and fuel usages that have been supplied, validated, audited, and stored from LCI data provided by other suppliers.

According to embodiments of the present invention, after received LCI data is validated, audited, and stored, the stored LCI data may be utilized in generating a life cycle impact assessments (LCIA) and LCIA scoring for a given good and/or service. For example, if life cycle inventory data provided by a grower of cotton that will be used in the downstream production of an article of clothing, life cycle inventory data from the provider may be used for generating a life cycle impact assessments for the production of a bale of cotton, or a life cycle impact assessments generated for the bale of cotton may be aggregated with life cycle impact assessments for other components of a the example downstream article of clothing for generating an overall life cycle impact assessment and eventual LCIA score for the article of clothing. That is, life cycle impact assessments may be generated for each component or process associated with a given good and/or service, or life cycle impact assessments may be generated for combinations of components or processes of a given good and/or service or for a final/composite good and/or service, for example, a cotton shirt. Likewise, LCIA scoring may be generated for components and/or combinations of components of a given good or service.

Life cycle inventory data received by suppliers of various goods or services may be structured according to a structured data language, may be annotated with one or more metadata items for storing, sorting, searching, retrieving and utilizing the life cycle inventory data items, and may be utilized in the generation of various life cycle impact assessment scores, as described above. According to one embodiment, when a supplier of a good and/or service provides life cycle inventory data for a given good and/or service, life cycle impact assessments may be generated for the provided good and/or service. That is, life cycle inventory assessments (LCIA) may be generated for each good or service for which life cycle inventory data are provided.

The LCIAs for the good or service may include producing scientifically verified potential impacts (e.g. climate change in kg of CO₂-equivalents, acidification in kg H⁺-equivalents) across an entire system. For example, for a bale of cotton produced by a farmer, LCI such as fuels used, fertilizers used, pesticides used, labor used, and the like, may be validated, audited and aggregated. From these data, a life cycle impact assessment (LCIA) may be generated for the bale of cotton showing an environmental and/or social impact of the bale of cotton for a variety of categories, such as impact on global warming in terms of produced and released CO₂-equivalents, acidification in terms of produced and released SO₂-equivalents, and the like. As should be appreciated, environmental and/or social impacts may be determined for a given good or service in terms of a great number of impact categories, including soil nutrient enrichment and utilization, photochemical smog production and release, land use, labor use, etc. For more information on life cycle assessment impacts and determinations, see ISO series 14040 which are incorporated herein by reference as if fully set out herein.

Prior to generating a life cycle impact assessments for a given good and/or service, a determination and mapping may be made of all the components or processing phases required for the production, use and even eventual disposal of the good and/or service based on life cycle inventory data received for the good and/or service from its supplier. Using metadata applied to each of the components or processing phases, life cycle impact assessments are located for each of the components or processing phases. For any component or processing phase for which an existing LCIAs are not available, a LCIAs may be generated based on LCI data supplied for the component or phase by its supplier. LCIAs for each of the components or processing phases for the good and/or service are aggregated together, and LCIAs for the good and/or service may be generated.

After life cycle assessment impacts are generated for a given product (good or service) those assessments may be used for determining a life cycle impact assessment score for the good or service that represents an overall environmental and/or social impact score (e.g., environmental “goodness” or “badness” according to a variety of scales) for the product. As should be appreciated, the LCIA score may be determined according to an almost limitless number of algorithms where each individual impact assessment for a given product is weighted differently by different LCIA scoring bodies. That is, the generation of an LCIA score for a particular product results from an algorithm that uses the impact assessments as input. The scoring is a way to distill or weight these impact numbers based on a value judgment to produce a single score. A given scoring algorithm/scheme may not agree with a given user's values. As such, a provision for users to examine the scoring methodology and apply their own weights is an important aspect of the system. The impact assessment is fact-based and scientifically rigorous. Scoring, on the other hand, is value-based or culturally-based. For example, one scoring body, for example, a farming association, may generate scoring for a produced crop where impacts on water toxicity are considered more prominently than impacts on climate change. Another scoring body, for example, a climatology association, may arrive at a different scoring for the same crop production owing to a higher emphasis or weighting applied to climate change impacts associated with the crop production. As should be appreciated, one or more government agencies or standard setting bodies may arrive at standardized weightings to be applied to LCIAs calculated for goods and/or services to reduce the uncertainties associated with such value judgments in the generation of LCIA scoring.

After LCIAs and LCIA scores are generated, they may be updated periodically as associated LCI for a given good and/or service changes as described below. Generated LCIAs and LCIA scores may be provided to various suppliers via a secure data exchange framework, and LCIA scores may be published to consumers via a variety of suitable means.

For example, LCIAs for a bale of cotton may be generated showing impacts of the production and/or use of the bale of cotton in association with a number of impact categories, such as global warming, acidification, nutrient enrichment, photochemical smog, land use, labor use, and the like. An LCIA scoring algorithm that applies a predetermined weighting to each of such impacts may be used for generating an LCIA score for the bale of cotton. If a life cycle impact assessment score for the bale of cotton that will be used in the downstream production of a cotton shirt is scored on a scale of 1 to 100, a bale of cotton produced by one cotton producer may receive a life cycle impact assessment score of 50, and a bale of cotton produced by a second cotton producer may receive a life cycle impact assessment score of 75. The life cycle impact assessment score of 75 may indicate to consumers of the bale of cotton including downstream manufacturers of cotton items, for example, cotton shirts, that the bale of cotton produced by the second provider is better in terms of environmental and/or social impact. If the bale of cotton having the better life cycle impact assessment score is ultimately used in a downstream production of a cotton item, for example, a cotton shirt, then a composite life cycle impact assessment score generated for the cotton shirt will be improved by use of cotton from the bale of cotton having the better life cycle impact assessment score.

Each life cycle impact assessment may be generated based on environmental and/or social impact attributes associated with each component or subcomponent of a given good and/or service. For the example bale of cotton, a first provider of bales of cotton may use heavy amounts of toxic pesticides owing to insect problems in the area of the first provider's cotton growing operation. The second cotton provider may utilize less or no pesticides owing to a lack of an insect problem in the area of his/her growing operation. On the other hand, the first example cotton grower may transport his bales of cotton using electric-powered transport vehicles, whereas the second cotton grower may transport his/her bales of cotton using diesel-fueled transport vehicles. Thus, where the introduction of pesticides may result in a lesser life cycle impact assessments for the bales of cotton produced by the first cotton grower, the use of diesel-fueled transportation vehicles by the second cotton grower may reduce the life cycle impact assessments for his/her cotton bales relative to the electric-powered transportation vehicles utilized by the first cotton grower. That is, the life cycle impact assessments generated for the example bales of cotton produced by the first and second cotton growers will take into consideration environmental and/or social impacts of each component or process involved in the production of the good and/or service.

According to embodiments, life cycle inventory (LCI) data associated with each component or process involved in the manufacture, use and disposal of a good, or in the development and provision of a service may be collected for ultimately developing a life cycle impact assessments (LCIA) for a given good or service to allow persons or entities engaged in the development, manufacture, distribution, use or disposal of goods or services to operate in an informative manner with respect to the life cycle of the goods or services. According to embodiments, each supplier of a good or service or each supplier of a component of a good or service (hereinafter collectively referred to as “product”) for which LCI data is desired or required provides a unit process data set for their respective products. The unit process data set includes data on all components or processes utilized by the supplier in the manufacturing, development, delivery, use or disposal of their respective products, including, energy, raw materials, processing methods, components of and information about use, components of and information about disposal, and the like. As should be appreciated data on various phases may vary greatly. For example, for disposal of a product, a recycled battery may have data associated with less environmental impact than for a battery that is discarded in a public landfill.

Providing unit process data for a given product may be performed according to a variety of methods. First cradle-to-gate or cradle-to-grave life cycle inventory data may be provided via a structured data template for organizing the data according to a prescribed structure required for processing the data. Second, the LCI data may be provided as raw data via a generic unit process model requested by the data supplier. Alternatively, a combination of structured data and raw data may be provided by a given supplier.

As will be described below, data provided by a given supplier may be passed through a distributed computing network, for example, the Internet or an intranet, to a life cycle inventory and assessment data hub where the data may be validated and/or audited, and where the data may be aggregated and scored in terms of its environmental and/or social impact with reference to the product for which the data is collected. The environmental and/or social scoring may be used by consumers of the product in determining the environmental and/or social impact associated with their consumption of the product whether their consumption is end use, or whether their consumption is involved in using the product in the development, manufacturing, use and/or disposal of one or more other goods and/or services.

For purposes of illustration, one or more examples will be described below. While a given example may apply more to environmental impact, such as the use of water, fuels, and chemicals, social impact is equally important where the social impact of the creation and/or use of a product may be of substantial importance. For example, if a given product is manufactured under inappropriate labor standards, such information may be quite useful in scoring a given product and in providing such information to potential consumers of the product.

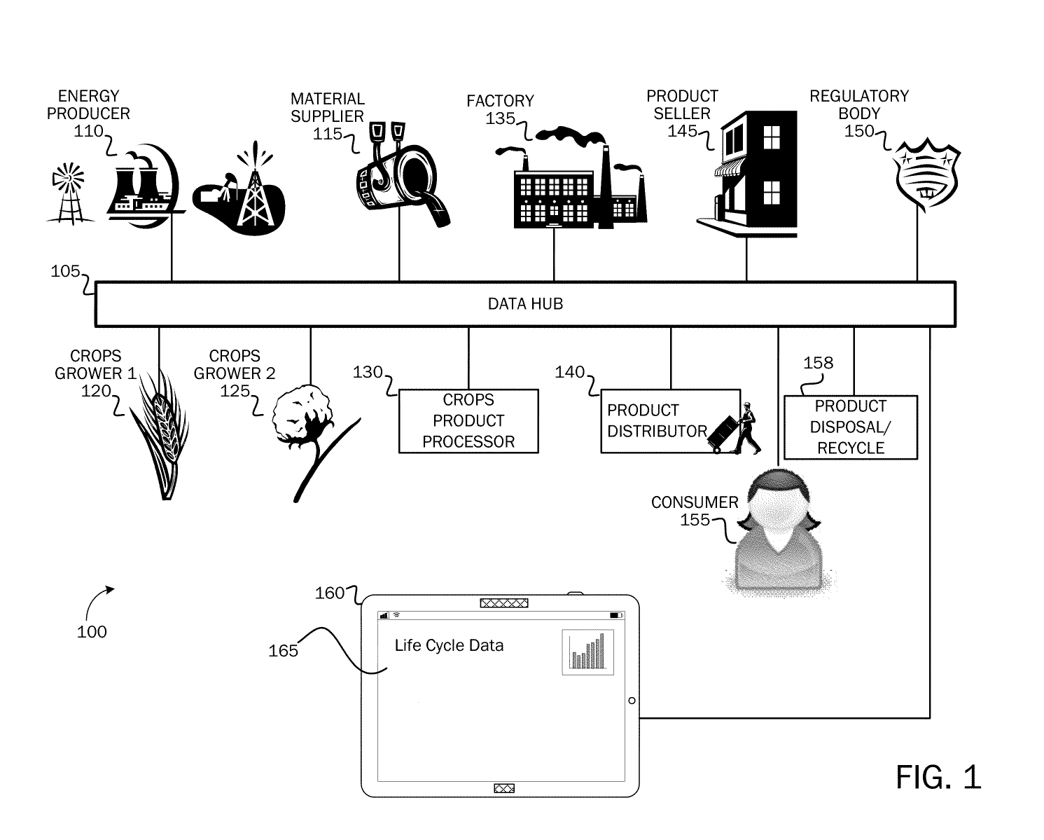

FIG. 1 is a simplified block diagram illustrating a life cycle of one or more goods and/or services from production through consumption. The components and processes illustrated in FIG. 1 are illustrative of a variety of suppliers of one or more products where such products may be in the form of components and/or services provided for and/or utilized in association with the development, production, use and/or disposal of one or more products. For example, referring to FIG. 1, an energy producer 110 is illustrative of a fossil fuels-based energy production provider, a solar or hydroelectric power energy provider, a nuclear-based energy provider, and the like. A material supplier 115 is illustrative of a manufacturer or supplier of a variety of materials, for example, raw materials, chemicals, natural and human-made materials, equipment, and the like. For example, the material supplier 115 may be a supplier of fertilizers or pesticides used in the production of crops. Likewise, the material supplier 115 may be a supplier of an intermediate component, for example, a manufactured component that it used in some other product or service.

The crop grower 120 and the crop grower 125 may be illustrative of one or more suppliers of natural materials, for example, crops, timber, mined ores, and the like. The crops product processor 130 is illustrative of a factory or processing unit responsible for transforming a raw material from one state to another. For example, the crops product processor 130 may be a manufacturing concern operative to transform raw cotton into cotton yarn or thread that may be utilized in the production of an article of clothing. The factory 135 is illustrative of a factory for processing one or more supplied materials into a useful intermediate or end-user product. The product distributor 140 is illustrative of one or more distribution systems, transportation systems, communication systems, warehousing or storage systems, involved in the processing, storage, delivery and/or utilization of one or more products.

The product seller 145 is illustrative of any organization operative to sell one or more intermediate or end-user products. A regulatory body 150 is illustrative of any organization tasked with overseeing, managing or regulating the development, manufacture, use or disposal of a product. A consumer 155 is illustrative of any intermediate user or end user of a product. For example, any of the entities 110-150 may indeed be a consumer of products, as described herein.

The disposal/recycle unit 158 is illustrative of a number of processes that may be applied to a given product at the end of its useful life. For example, a product may be disposed of in a landfill or other disposal site, a product may be incinerated, and the like. All of such disposal methods may be associated with a number of environmental and social impacts. In addition, the disposal/recycle unit 158 may be illustrative of recycling processes or reuse processes where products or components of products may be recycled for subsequent use or where products may be reused in their current or altered forms.

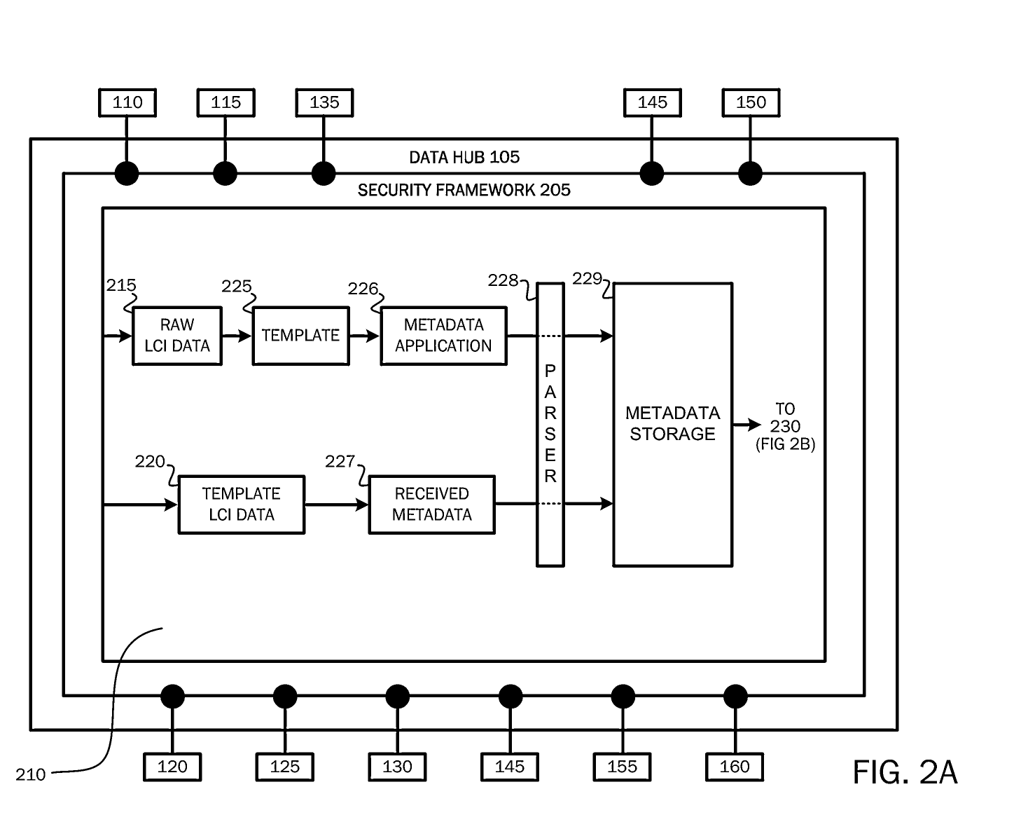

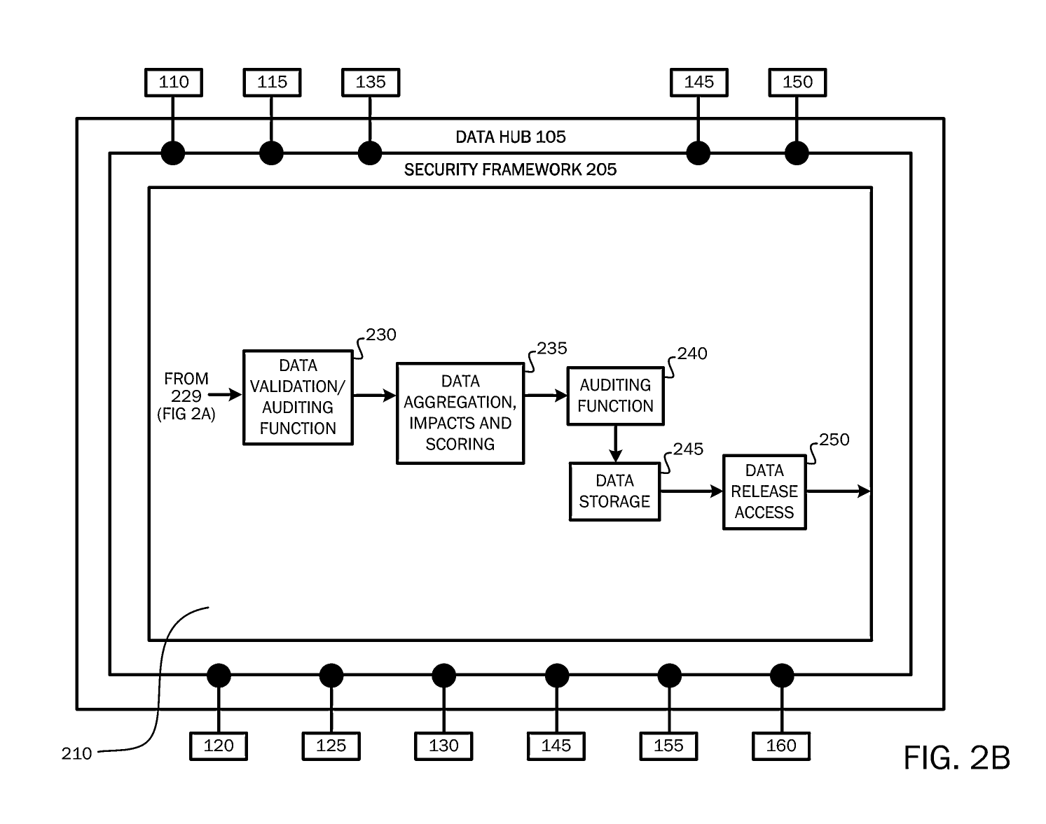

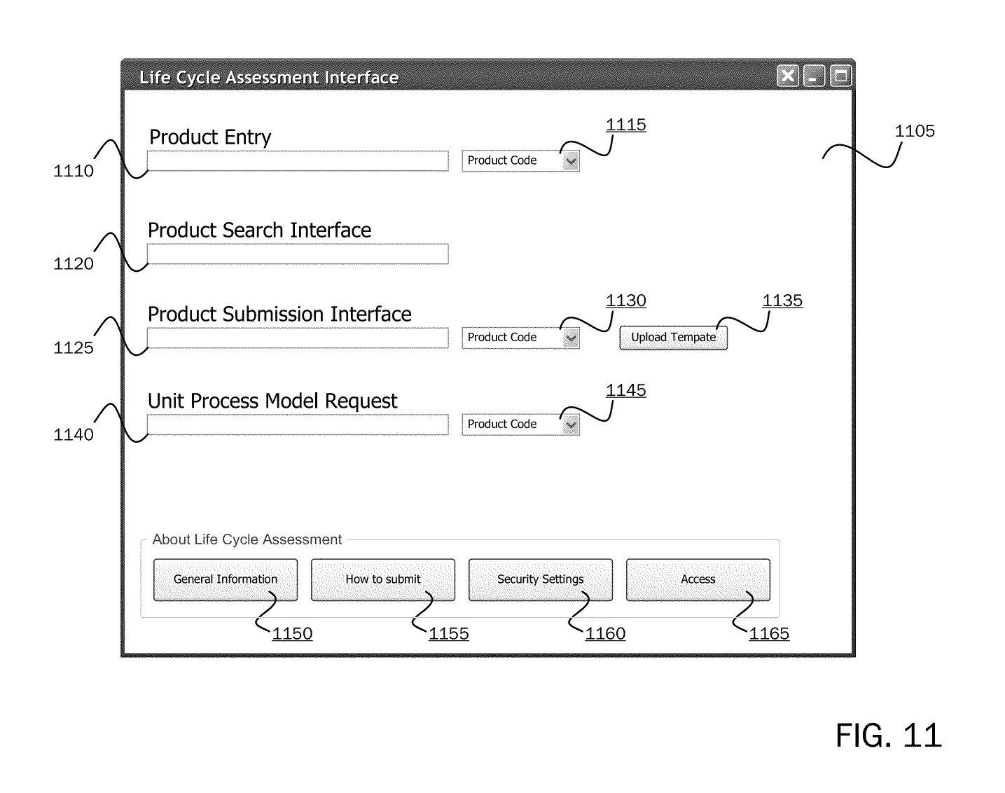

As will be described below with reference to FIGS. 2A, 2B, the life cycle inventory and assessment data hub 105 is illustrative of one or more computing components and data repositories to which life cycle inventory data may be passed for organization, validation and/or auditing, aggregation, storage, and release to one or more users of the life cycle inventory data. The computing device 160 is illustrative of any computing device, described below with reference to FIGS. 11, 12A, 12B and 13 with which life cycle inventory and life cycle impact assessment data may be presented, processed, accessed and released, as described herein. The display screen 165 on the computing device 160 is illustrative of a computer-enabled display screen on which may be displayed one or more life cycle inventory and/or life cycle impact assessment data items, as described herein.

According to embodiments, each of the components of the system architecture illustrated in FIG. 1 may operate as standalone components that are operatively connected with the data hub 105 for providing and receiving life cycle inventory and life cycle impact assessment data in association with their respective products. That is, each of the supplier entities 110-155 may be independent operating entities located at disparate locations around the world and that are operative for providing their respective products as intermediate or end-user products. The data hub 105, and its components, described below with reference to FIGS. 2A, 2B, may operate as a collection of computing devices and data storage repositories at a single location, or the components of the data hub 105 may be operated as a distributed computing network where one or more of the components of the data hub 105 may be located at disparate locations relative to other components of the data hub 105, all of which may be connected via a distributed computing network, such as the Internet or an intranet.

As will be described herein, each supplier in a given product life cycle may submit life cycle inventory data on his/her products through the data hub 105, and the life cycle inventory data for all products associated with or combined as part of the life cycle of a given product may be aggregated for a scoring of individual products and for ultimate products into which individual products are combined or with which individual products are utilized. For example, consider that the suppliers illustrated in FIG. 1 are associated with the manufacturing of a shirt or other article of clothing. According to an embodiment, the energy producer 110 may provide life cycle inventory data associated with all components required for the production of energy, a crop grower 120, 125 may provide life cycle inventory data associated with all aspects of crops production, for example, fertilizers, pesticides, fuels, labor, and the like associated with growing cotton, the factory 135 may supply data associated with manufacturing processes required for transforming cotton thread or yarn into fabric with which a shirt or other article of clothing may be made, the distributor 140 may submit life cycle inventory data associated with all aspects of distribution of a manufactured shirt or other article of clothing, for example, fuel types and usage data, warehousing capacities, utilization, heating and cooling statistics, and so on.

According to embodiments, the life cycle inventory data submitted by each supplier may be used for generating environmental and/or social impacts for that product, and ultimately the environmental and/or social impacts associated with each intermediate component, for example, energy, crops production, manufacturing, storage, distribution, and the like, may be aggregated together to generate an environmental and/or social impacts for an end product, for example, a shirt or other article of clothing. The environmental impacts generated from the life cycle inventory data provided by each supplier may then be used by each supplier to determine which intermediate component the supplier desires to use in their products. Downstream users of an end-user product may utilize the life cycle impact assessments generated from the life cycle inventory data provided by each supplier to determine whether the users desire to use a given product as opposed to another product based on the life cycle impact assessments for two competing products. As should be appreciated, a given supplier likely would use mean or median aggregated impact data to inform the supplier of how it is performing compared to the mean or median impact values.

Referring now to FIGS. 2A, 2B, one or more components and/or systems comprising and interacting with the life cycle inventory (LCI) and life cycle impact assessment (LCIA) data hub 105 are illustrated and described. As described above, the data hub 105 includes a number of computing systems and/or data storage repositories operative to receive and process life cycle inventory data associated with a variety of intermediate and/or end-user products including information about components and/or processes involved in the development, manufacture, use and disposal of one or more intermediate or end-user products.

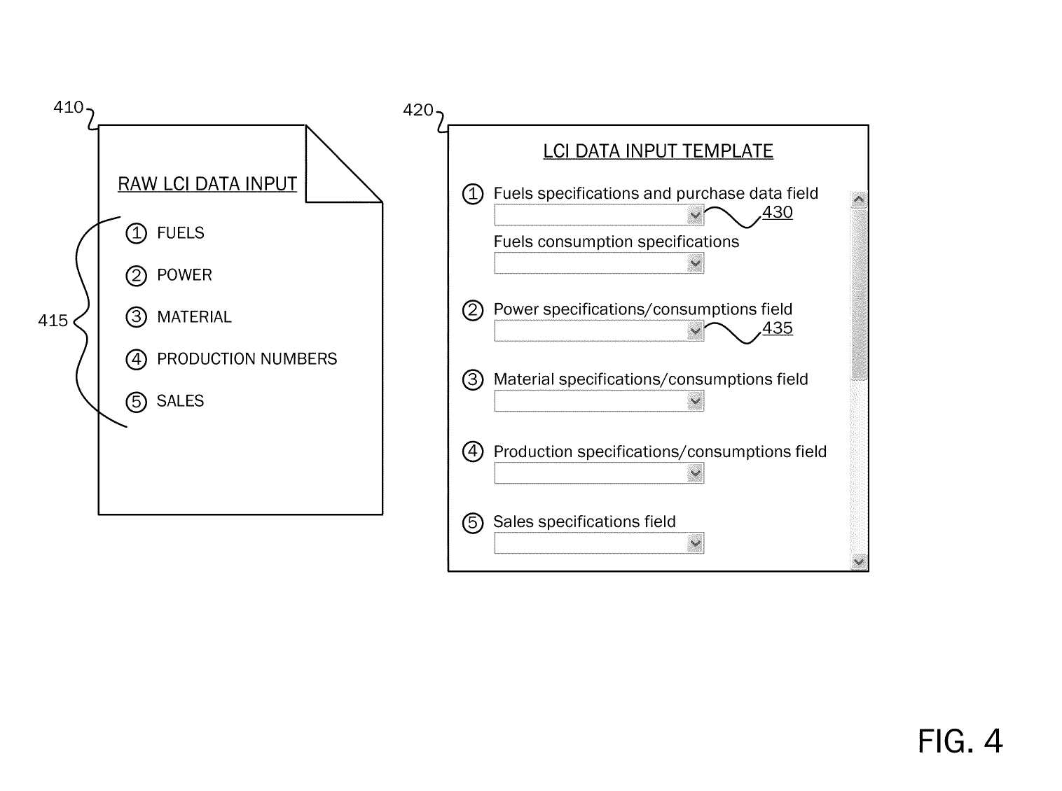

A security framework 205, described below with reference to FIG. 4, is operatively positioned between suppliers 110-155 and the data hub 105 in order to provide secure access to the data hub 105 and in order to prevent unauthorized or unsecured access to the data hub 105. As should be appreciated, life cycle inventory and life cycle impact assessment information for various products (both intermediate and end-user products) may be highly sensitive information having a great impact on the competitive positions of one supplier versus another supplier, and consequently, information obtained from various suppliers must be secured from access by other suppliers to allow suppliers the comfort of knowing they can provide life cycle inventory information on their products and services without being concerned that that information may be exposed to other suppliers which may allow other suppliers to be aware of competitive advantages/disadvantages associated with their products. Such concerns on the part of a given supplier of LCI and LCIA information may discourage or prevent the sharing of valuable life cycle inventory information, as described herein, if the sharing of such information cannot be done in a secure manner.

According to embodiments, an individual supplier 110-155 may submit life cycle inventory data, for example, fuel usage, energy usage, raw material usage, raw material processing data, transportation information, and the like, through a variety of means. According to one method, a supplier may submit raw business or business transaction data 215 to the data hub 105 for automated processing by the data hub 105. As used herein, raw business or business transaction data may include any data a supplier may have on processes or materials used by the supplier in the manufacture or use of a given product, but for which the supplier cannot provide life cycle inventory data in a structured manner, as will be described herein. Examples of such raw business or business transaction data include purchase data, sales data, amounts of processes or materials used, and the like. As described herein, such raw business and business transaction data ultimately may be converted into LCI data. For example, if the supplier lacks equipment, personnel, or otherwise, lacks the technical sophistication for presenting life cycle inventory in a structured manner, as described below, raw business or business transaction data may be presented by the supplier. For example, if the crops grower supplier 120 is in the business of growing cotton for use in the manufacture of clothing items, the crops grower may not have equipment, personnel, or access to technical means for presenting his/her life cycle inventory data in a structured manner, as described below. Thus, the crops grower may submit raw business or business transaction data 215 to the data hub 105.

For the example crops grower, such raw business or business transaction data may include amounts and types of fuel usage for farming equipment, amounts and types of fertilizers and pesticides used, amounts of labor used, including, information about labor-providing personnel, amounts of crops produced, durations of crops production, and the like. If the supplier has additional information about each life cycle inventory data item, for example, material safety data sheets associated with chemicals, for example, pesticides and fertilizers, brand names associated with fuels or other energy sources, purchase orders providing data associated with various raw materials used in the supplier's processes, and the like, such information may be provided with the raw business or business transaction data for assisting in structuring, validating and auditing the information received from the supplier.

If raw business or business transaction data is provided by a supplier, the received data may be automatically populated into a template 225 received via a generic unit process model, as described below with reference to FIG. 4, for providing data structuring to each received data item so that structured data items received by the supplier may be used by one or more computing processes described herein for validating and auditing the information, for aggregating and scoring the information, and for ultimately storing and releasing the information to other requesting suppliers.

According to one embodiment, such a supplier desiring to submit raw business or business transaction data may request via the data hub 105 a generic unit process model from the data hub 105 to allow the supplier to provide raw business or business transaction data. Such a model provided by the data hub 105 may be based on a product category rule (PCR) that applies to the supplier's product. For example, if the supplier's product is raw cotton, then a data model based on a product category rule applied to other suppliers of raw cotton may be presented to the supplier to assist the supplier in providing the raw business or business transaction data in a manner such that the data may ultimately be structured via the template 225 for use by the processing components of the data hub 105.

The product category rule-based model may be defined by one or more standards bodies, for example, the International Organization for Standardization (ISO). The product category rule-based model may be utilized and may be provided by comparing the finished products categorization (e.g., finished product being raw cotton, or finished product being one or more end products including raw cotton) with that of the product category rule to be applied to the example raw cotton. Once the supplier receives the unit process model, the supplier may then complete a template associated with unit process model with required information. For example, a unit process model for the production of raw cotton may provide a template 225 having fields to allow a supplier to enter data, as described above, such as fuel types and usages, pesticide and fertilizer types and usages, labor usage, production quantities, production durations, and the like. The data provided via the unit process model may include, but is not limited to, purchase orders, invoices, sales information, production locations, vendor information, customer information, descriptions of technologies used, and the like. Such information may allow for validation and auditing and ultimate scoring of the data, for example, where a technology used by one supplier has a greater environmental or social impact than a technology used by another supplier. For example, the use of human labor versus the used of mechanized production may impact both the environmental and social scorings applied to a given product. Use of the unit process model may allow for the data provided by the supplier to be compared with other similarly situated or types of data to allow for data validation and auditing via the data hub 105.

Alternatively, referring still to the data hub 105, a given supplier 110-155 may provide life cycle inventory data in a structured manner via a template 220 with which the supplier submits complete life cycle inventory data that the supplier collects, annotates, and organizes using one or more business data systems, direct measurement, databases, and research. For example, if a supplier is a highly sophisticated organization in the business of manufacturing a chemical that may be a down range component or constituent of an end-user product, such a supplier may possess or be associated with laboratories, accounting functions, manufacturing and data measurement functions, and the like to allow the supplier to collect detailed life cycle inventory data and to organize the collected data into one or more sets of collected data for provision to the data hub 105 via a template 220. For example, such a supplier may be fully capable of measuring and documenting energy consumption associated with the production of a given product or component, the supplier may be capable of assembling accounting data associated with labor statistics involved in the production of a given product, and the like.

As described above, any given supplier may provide life cycle inventory data to the data hub 105 either as raw business or business transaction data, or as structured life cycle inventory data. Alternatively, a given supplier may provide life cycle inventory data to the data hub 105 in a combination of these two data provision methods. That is, a given supplier may possess sophisticated and detailed life cycle inventory data generated via its own processes or via its own ability to obtain such data, but such a supplier may also utilize one or more intermediate or end-user products in its processes for which it does not have such detailed life cycle inventory data. In such a case, the supplier may present structured life cycle inventory data via a template 220 for products for which it possesses such data, and the supplier may present raw business or business transaction data 215 via a unit process model template 225 for any intermediate or end-user products the supplier utilizes for which it does not have detailed life cycle inventory data.

Whether LCI data is provided by a supplier as structured LCI data or as raw business or business transaction data, for purposes of validating and auditing the data, as described below, certain data qualifiers may be required for each data item. For example, if the data item is for an automobile, the automobile may have been manufactured at one of three different plants utilized by the manufacturer, each of which may have built the particular model at a different time, using different power sources (e.g., nuclear power versus hydroelectric versus wind power), and using different parts (e.g., different batteries from different battery suppliers, depending on plant location). Thus, for LCI data provided for such a product, the data hub and associated systems (e.g., validation/auditing function) may require data qualifiers, such as date/time of manufacture, location of manufacture, parts differentiation based on location, and the like. That is, information for some products/services may require versioning to account for such data differences for products bearing the same model identification.

Referring still to FIGS. 2A, 2B, once life cycle inventory data is received from a given supplier, the data may be passed through a data validation and auditing function 230. The data validation function 230 may validate data received by a given supplier to determine whether the information received by the supplier is correct for the type of information received. For example, if a supplier provides information that it has utilized a certain number of metric tons of hydroelectric power where hydroelectric power is utilized in terms of kilowatt-hours as opposed to metric tons, the validation function may notify the supplier and ultimately may reject the data if the supplier does not correct the information it has provided.

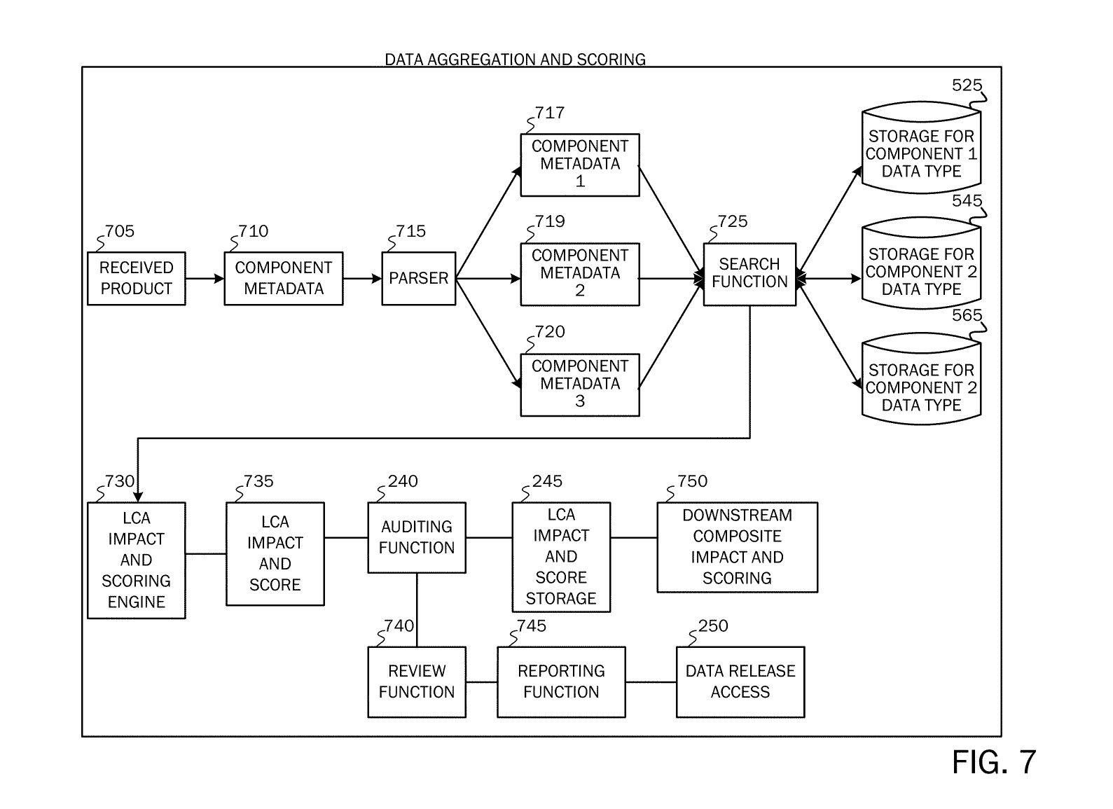

The auditing function 230 may compare received data against other similar types of data to determine whether the received data appears to be accurate in comparison with other similar types of data. For example, if a given supplier presents life cycle inventory data for a pesticide showing that the pesticide has certain toxicity levels beneath a desired threshold for toxicity, the data auditing function 230 may compare that information with toxicity levels known for other pesticides of the same pesticide type, for example, pesticides having the same or similar chemical make-ups and/or structures. If the information provided by the supplier, for example, the toxicity levels for a given pesticide, is out of range with other similarly utilized products, the auditing function 230 may notify the providing supplier and may reject the information. After life cycle inventory data is received, validated, and audited, the data may be aggregated and scored for a given product by the data aggregation, impact and scoring function 235, as described below with reference to FIGS. 7-10

After life cycle inventory data is aggregated and assessed, the data may be passed through another auditing function 240 for comparing life cycle impact assessments for the associated product with other similarly situated or types of products. The life cycle impact assessment information may be stored in a storage repository 245, and ultimately the life cycle impact assessment information may be released through a release access point 250. According to an embodiment, the data release access point 250 may allow suppliers to obtain life cycle inventory data and life cycle impact assessment data for one or more products by accessing the data hub 105 via the secure framework 205.

As should be appreciated, in addition to life cycle impact assessment scoring generated for one or more life cycle inventory items, suppliers may request life cycle inventory data that has been received from other suppliers and that has passed through the data validation and auditing function 230. That is, before life cycle inventory data is aggregated and scored, or apart from aggregation and scoring, one or more other suppliers may request and receive life cycle inventory (LCI) data for one or more products. For example, the second crops grower 125 may request through the secure framework 205 life cycle inventory data provided by the first crops grower 120 to assist the second crops grower 125 in modifying its crops growing processes to include a modification of the life cycle inventory components or processes it uses.

As described below, release of such LCI data from one particular supplier to another supplier may present business, security or competition risks to the releasing supplier. Thus, according one embodiment, requested LCI data may be provided to a requesting supplier 125 in aggregate as a mean and median for comparative purposes without explicit authorization (other than being in the data hub to begin with), provided the data hub has sufficient aggregation of data to make data anonymous. For example, if the second crops grower desires LCI data for fuel usage by other similar crops growers, the requesting supplier may be provided with an average LCI data for fuel usage across a number of similar crops growing operations. If the data hub has access to only one data point, and provision of a mean or median or other statistically significant data type for the requested information is not available, then provision of the requested data may be restricted.

For example, if certain information provided by a given supplier, for example, the first crops grower 120, is proprietary in nature, for example, a proprietary combination of one or more intermediate products used in the production of an end-user product, then such information may be secured from access by another supplier. According to embodiments, a given supplier may indicate that certain life cycle inventory information is proprietary, and upon approval by the data hub 105, such life cycle inventory information may not be released to other requesting suppliers. For example, if a certain combination of components is proprietary in nature, the combination of the components may not be released to other requesting suppliers, but information on individual components may be released to requesting suppliers. The data aggregation, impact and scoring component 235, the auditing function component 240, the data storage component 245, and the data release access component 250 are illustrated in FIGS. 2A, 2B in simplified block diagram form. A more detailed illustration and description of components of each of these components and other components accessed by each of these components in the generation, auditing, storage, and release of life cycle impact assessment scoring are illustrated and described below with reference to FIG. 7.

Referring still to FIGS. 2A, 2B, additional components and/or processes associated with the life cycle inventory and assessment hub 105 are illustrated. As described above with reference to FIGS. 2A, 2B, structured LCI data obtained either via the template 225 utilized by a supplier in association with or from a unit process model requested by the supplier or structured LCI data received directly from the supplier via the LCI data template 220 are passed to the data validation/auditing function 230 for validating the data against similar data to ensure that the data received is proper in terms of its intended use (e.g. metric tons versus kilowatt-hours), and the received structured LCI data is audited to ensure the accuracy of the data in comparison to other similar types of data.

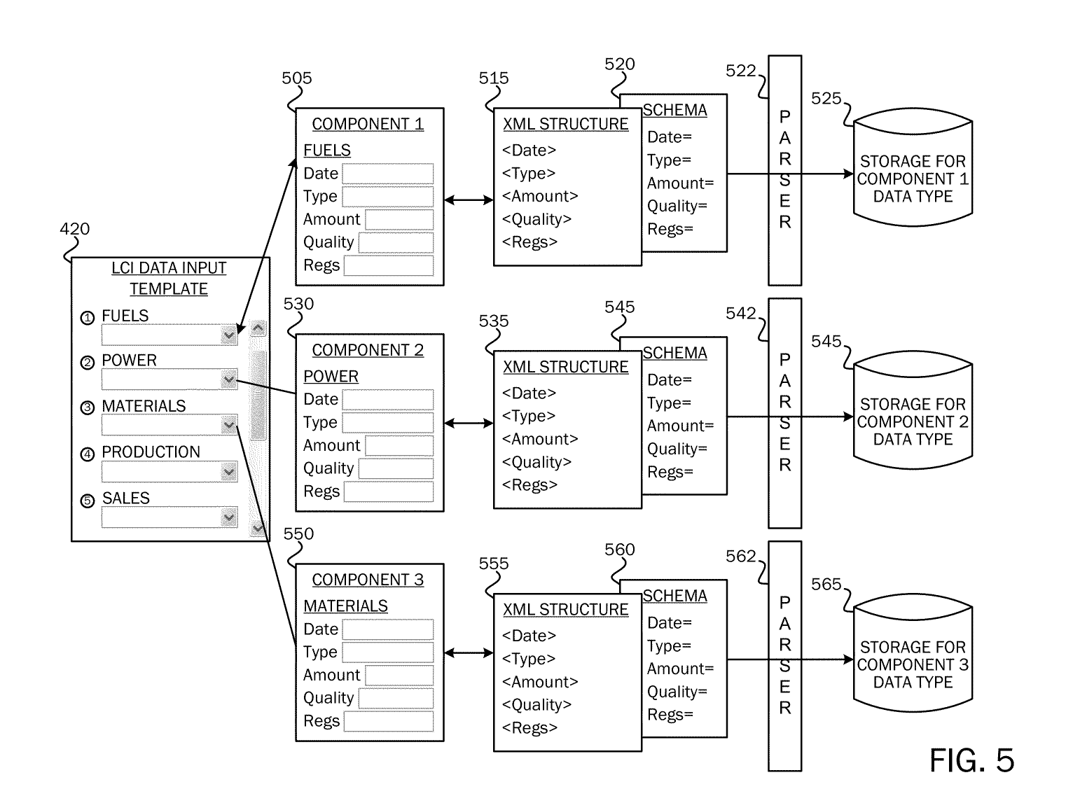

As illustrated in FIGS. 2A, 2B, between the templates 220, 225 and the data validation/auditing function 230, metadata application components may be positioned for applying and/or retrieving metadata applied to received LCI data that may be used downstream for identifying, storing, searching and retrieving received LCI data. The metadata application 226 is illustrative of a software component and related process step with which metadata may be applied to LCI data received from a supplier via the template 225 for applying metadata to each received LCI data item. For example, as described below with reference to FIG. 5, for each data item received, for example, fuel data, pesticide data, fertilizer data, and the like from a given supplier, a variety of metadata items may be applied to identify each data item for downstream use of the data items. That is, metadata may be applied to each received item so that subsequent processes may sort the data, store the data, retrieve the data and use the data in the generation of life cycle impact assessment scoring for products containing components or processes associated with each of the received data items.

The received metadata 227 is illustrative of metadata applied to the LCI data received via the LCI data template 220 automatically when the data was populated into the template by the data supplier/provider. For example, if a sophisticated supplier of LCI data uses a structured data template for providing LCI data on one or more products or components of one or more products, entry of the required data, for example, fuel types used, dates of fuel usage, amounts of fuel usage, and the like, entry of the data into the fields of the structured data template 220 may result in the automatic application of metadata to each entered data item so that the data items may be stored, sorted, searched, and retrieved in association with downstream processing.

The parser 228 is a software application module operative to parse metadata applied to LCI data for allowing each metadata item to be stored in an appropriate location in association with the metadata storage repository 229. As should be appreciated, individual data items may be stored in a variety of storage repositories, and the metadata items applied to each such data item and stored in the storage repository 229 may be utilized by a downstream process, for example, the validation and auditing function 230, for locating a given data item. For example, a metadata item applied to a given LCI data item such as fuel type may serve as an identification for the actual fuel type data item. Storage of the metadata item associated with the actual data item may be used by downstream processing modules, for example, the data validation and auditing function 230, for locating the actual data item using the stored metadata item. For example, if a stored metadata item identifies a fuel type used in a given product, a downstream processing module may use the stored metadata item for locating the actual data item, for example, the fuel type associated with a given product, and for obtaining information about the data item, for example, information about the utilized fuel type.

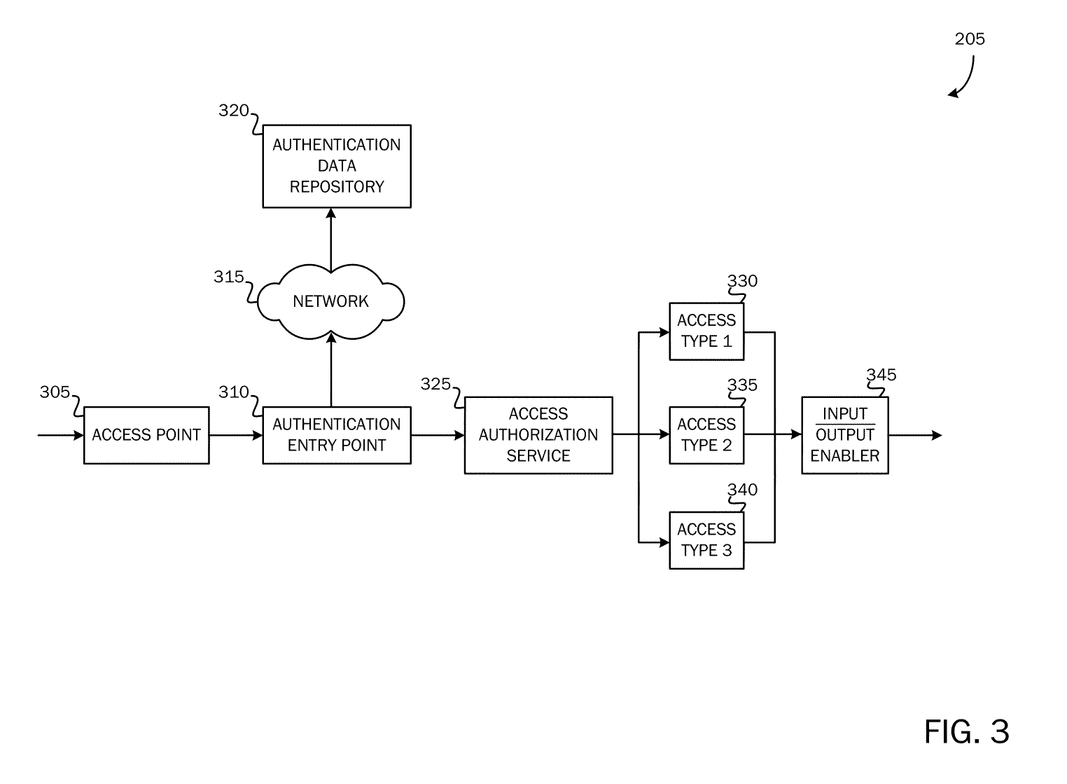

Referring now to FIG. 3, as described above, a security framework 205 may be operated between suppliers and the data hub 105 and between one supplier and another supplier to secure data provided to and received from the data hub 105 from unauthorized access. The system architecture illustrated in FIG. 3 is one example of a security framework system architecture, but is not limiting of a vast number of security frameworks that may be employed for securing access to data provided to and retrieved from the data hub 105.

An access point 305 is illustrative of one or more access points with which a supplier may gain access to the data hub 105. According to one embodiment, the access point 305 may operate as a web services platform through which a supplier may access the data hub 105 through an Internet-based web page. The access point 305 likewise may operate according to a variety of other telecommunications-based access points to allow a supplier computing device to obtain access to the computing devices and/or storage repositories of the data hub 105.

An authentication entry point 310 is illustrative of a software application module operative to obtain authentication information from a supplier and to pass the authentication information to an authentication data repository 320 via a distributed computing network 310 or to a local authentication data repository 320 for obtaining authentication information. For example, the authentication entry point 310 may provide a dialog box to a requesting supplier requiring that a requesting supplier enter a password or other authenticating information for determining whether the requesting supplier may have access to data contained in the data hub 105. Once the authentication entry point 310 receives requested authentication information from the supplier, the authentication entry point may obtain authentication information for the requesting supplier from the authentication data repository 320. The access authorization service 325 may compare information received by the requesting supplier with information stored for the requesting supplier to determine whether the requesting supplier may have access to the computing systems and data of the data hub 105.

If the requesting supplier is granted an access privilege for access to the data hub 105, one or more access types 330, 335, 340 may be granted to the requesting supplier. For example, a first access type 330 may allow the supplier to provide LCI data and to request and receive LCI data associated with its own products only. A second access type 335 may allow the supplier to enter or provide LCI data and may allow the supplier to request LCI data for its own products as well as for a specified group of other products. A third access type 340 may specify a limited access by a requesting supplier of certain types of data, but may specify certain other types of data to which the supplier may not obtain access. For example, as described above, certain information contained and processed by the data hub 105 may include proprietary information, for example, specific combinations of components used by another supplier for achieving a desired result. The access authentication service 325 may grant an access type to a requesting supplier that restricts the requesting supplier from such proprietary data. The input/output enabler 345 is a software application operative to allow the requesting supplier to input LCI data and to receive LCI data in accordance with the access type granted to the requesting supplier.

As described above, suppliers may provide life cycle inventory data either as raw business or business transaction data in association with a unit process model, or suppliers may provide detailed life cycle inventory data according to a structured data template for use by the data hub 105. Referring to FIG. 4, the raw LCI data input document 410 may include a document of various types, for example, a word processing document or spreadsheet application document, with which a supplier may provide life cycle inventory information associated with a given product. For example, data 415 may be provided such as fuels data, power type and consumption data, materials data, production numbers, for example, bales of cotton produced during a given period, sales information, and the like.

According to embodiments, a certain degree of data structuring may be required for the raw LCI data input document 310 in order for the associated data to be transformed by the data hub. For example, data headings or data metadata applied to various provided data points may be required to allow use of the data by the data hub 105, as described herein.

As described above, the raw business or business transaction data may be provided to the data hub 105 by a given supplier if the given supplier lacks the ability to provide the data in any structured manner, or according to a requested unit process model. Raw business or business transaction data received via a document 410 may then be automatically parsed and inserted into appropriate fields of a unit process model template or life cycle inventory data input template 420, described below.

The template 420 is illustrative of a structured data template with which a supplier may provide detailed life cycle inventory information where such information is available to the supplier. According to one embodiment, the template 420 may be obtained via a unit process model requested by a supplier and may contain fields for entering specific information about life cycle inventory data, for example, specific information about fuel types and usage, power usage specifications and consumption rates, materials and components information, production specifications, sales specifications, and the like. Thus, a supplier who has the ability to provide detailed LCI data may utilize the template 420 without the need for requesting a unit process model for providing LCI data to the data hub 105. As should be appreciated, the data are the actual values for particular product or service, for example, fuels, power, materials, production, and sales that a supplier provides to the data hub 105. The metadata are the properties of these input data items. For instance, one is named “Fuels” and is stored as an enumerated field with options “electric,” “hydroelectric,” etc.

FIG. 5 is a simplified block diagram illustrating application and management of metadata associated with life cycle inventory data items. As described above, suppliers of life cycle inventory data that may be ultimately used by other suppliers/requesters of life cycle inventory data and that may be used in the generation of life cycle impact assessments for products and/or components of products may be received from suppliers of information via a structured data template 420, described above with reference to FIG. 4. The structured data template 420 may be in the form of a structured data template provided by the supplier of life cycle inventory data in a first instance, or the structured data template 420 may be provided by a supplier after the supplier requests a unit process model in association with other similar LCI data and with which the supplier may enter LCI data so that the LCI data may be structured for downstream use.

Once a structured data template 420 is received containing LCI data, metadata may be applied to and/or extracted from the structured data template 420, as briefly described above with respect to FIGS. 2A, 2B. That is, if the structured data template 420 is received from a sophisticated provider of LCI data that has the capability of providing a full LCI data set via an LCI data set template 220, all required metadata may be applied to various LCI data items by use of the full set LCI data template 220 by the supplier. On the other hand, if the information provided by an unsophisticated supplier of LCI data is provided via a unit business process model requested by the supplier of LCI data, then additional metadata application may be required in order for efficient management and utilization of components of the LCI data in downstream processes.

For example, if LCI data presented by a crops grower utilizing a full data set LCI template 220, individual data items, for example, date of fuel purchase, amount of fuel purchase, type of fuel purchased, durations of fuel usage, and the like may have been entered by the supplier in a structured data template 220, and the metadata may be applied to each of these types of data so that each of these types of data may be identified, stored, sorted, searched and retrieved by downstream processes. Alternatively, if metadata has not been applied to each data item and each information item associated with each data item, for example, date of fuel usage associated with a fuel data item, then application of such metadata may be automatically applied to the data by the metadata application process 226, described above with reference to FIGS. 2A, 2B.

Referring still to FIG. 5, the structured LCI data template 420 having applied metadata, either initially applied by the supplier, or applied for the supplier via the metadata application process 226, is illustrated. For each data item contained in the structured data template 420, a metadata file 505, 530, 550, and so on may be generated by extracting metadata associated with each data item contained on the structured data template by the parser 228, illustrated in FIGS. 2A, 2B above. That is, the parser 228 is a software application module operative to parse the data items contained in the received structured data template 420 for obtaining additional data items or sub-data items associated with each main data item provided in the structured data template 420.

Referring to the data file 505, for the fuels component illustrated in the structured data template 420, a variety of additional data items or sub-data items are extracted by the parser 228. For example, a date of fuel purchase, a fuel type, an amount of fuel, a quality associated with the fuel, and any regulatory information associated with the fuel are extracted from data entered by the supplier via the structured data template 420. That is, each of these additional data items or sub-data items associated with the main fuels data item may be extracted from the structured data template 420 owing to the application of metadata for each of these additional data items or sub-data items that identify each of the additional or sub-data items individually.

The data file 530 is illustrative of additional data items or sub-data items associated with a second LCI data item provided by the supplier of the structured data template 420, for example, power or other utilities associated with the product for which the structured data template 420 is provided. A third data file 550 is illustrated containing similar additional data items or sub-data items for a third LCI data item or component (e.g., raw materials) provided by the supplier via the structured data template 420. As should be appreciated, data files 505, 530, 550 are illustrative of a variety of data items that may be associated with received LCI data and that may be extracted from a received LCI data template by the parser 228 for use in downstream processing, including the generation of life cycle impact assessment scoring for a given product.

Referring still to FIG. 5, according to embodiments, the metadata applied to individual LCI data items, for example, fuel, materials, transportation, distribution, and the like and the metadata associated with additional data items or sub-data items underneath each of those LCI data items, for example, data of fuel purchase, amount of fuel used, type of fuel used, and the like, may be structured according to a structured data language. One example structured data language is the Extensible Markup Language (XML), but as should be appreciated, XML is only one example of a structured data language with which individual data items may be structured to assist in storing, sorting, searching, retrieving, and utilization of data items to which one or more metadata items have been applied in association with a structured data language.

Example structured data language files 515, 535, 555 are illustrated in association with the data files 505, 530, 550 showing markup tags that may be applied to each data item for structuring the data item and metadata associated with the data item to allow the data item and the associated metadata item to be stored, sorted, searched, retrieved and utilized. For example, a markup tag of <date> may be applied to both a data item comprising the actual date of an example fuel purchase and may be applied to a metadata item associated with an actual data item showing a date of the example fuel purchase such that the metadata item may be used for locating and retrieving the actual date of the example fuel purchase. As should be appreciated, the example structured data language illustrated in the files 515, 535, 555 is not intended as an illustration of a well-formed structured data language file, but is intended for purposes of illustration only.

Behind each structured data language file 515, 535, 555 may be an structured data language schema file 520, 540, 560 that may be associated with each of the respective structured data language files for providing definition of the structured data language markup tags applied to each data item and each associated metadata item. That is, the structured data language schema files provide definition to any downstream parsing application capable of consuming and reading structured data language markup in association with an attached or related structured data language schema file to allow the parser to identify individual data items in a given data item file 505, 530, 550 so that individual data items may be stored, sorted, searched, retrieved, and utilized.

The parsers 522, 542, 562 are illustrative of parsing applications capable of reading the data files 505, 530, 550 in association with the structured data language markup 515, 535, 555 applied to data items, additional data items, and sub-data items contained in the received data item files. The parsers 522, 542, 562 are further operative to store each received data item in a storage repository 525, 545, 565 associated with data items of the same or similar type. For example, data items received for fuels used by an example supplier and the associated metadata applied to the data items and sub-data items, for example, date of fuel usage, fuel type, amount of fuel usage, and the like that are structured according to a structuring language, for example, XML, may be extracted from the file, and may be stored in a storage repository 525 associated with data received from other suppliers for data of the type “fuels.” Similarly, data illustrated in the data file 535 for power usage may be stored in a data repository 545 along with information from other suppliers related to the data type “power.”

As should be appreciated, such a data repository 525, 545, 565 may be established for containing various data items of various data item types and/or metadata associated with such various data items for provision to requesters of life cycle inventory information, or for use in the generation of life cycle impact assessments. For example, a subsequent product supplier may request life cycle inventory data regarding a variety of fuels with certain characteristics in order to decide which type or types of fuel would best meet its needs. Metadata associated with previously stored data items for fuel types and fuel usages of other suppliers may be used for searching life cycle inventory data associated with fuels from the storage repository 525 to provide to the requesting supplier.

For another example, during a validation and/or auditing process, described above with reference to FIGS. 2A, 2B, fuel information received by a product supplier may be compared with other similar fuel information previously stored in the data repository 525 to determine whether the LCI data provided by the supplier for fuels is valid and accurate as compared with fuel information previously received from other suppliers and stored in the data repository 525. As should be appreciated, the data stored in the data repositories 525, 545, 565 may be metadata only that may be used for locating associated actual data items, for example, actual data items related to fuel usages, that are stored in other storage repositories remote from the storage repositories 525, 545, 565, illustrated in FIG. 5.

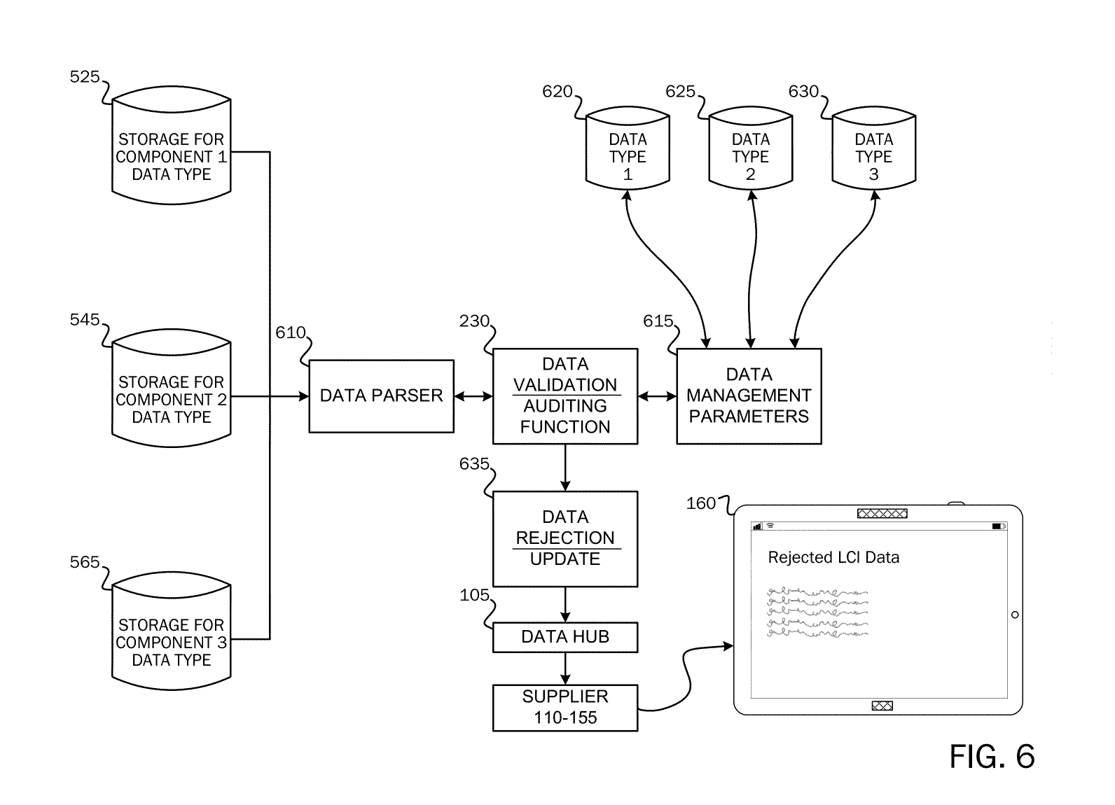

FIG. 6 is a simplified block diagram of a system architecture for parsing stored metadata associated with life cycle inventory data items and for comparing stored metadata with one or more data management parameters. As described above, after LCI data is provided to the data hub 105 as either raw business or business transaction data or as structured data, the data hub 105 may validate and audit the received data to determine whether the received data may be utilized in a data aggregation and scoring process, described above. The data repositories 525, 545 and 565, described above, may be queried by the data validation and auditing function 230 via the parser 610. That is, the data items and/or metadata items for received LCI data may be retrieved from the data repositories via the applied metadata and structuring described above with reference to FIG. 5.

For each data item retrieved via the data repositories 525, 545, 565, the data validation/auditing function 230 compares the received LCI data items to one or more data management parameters 615 to determine whether the data items received by the supplier contain sufficient information for a validation and auditing analysis of the received data. For example, if a supplier provided LCI data via a structured template 420, as described above, the validating function 230 may review the received data and compare the received data to similarly received data sets to determine whether enough data has been presented to allow for further use and analysis of the received data. Such received data sets to which the LCI data may be compared may be located in the storage repositories 620, 625, 630 according to data types, for example, fuels, iron ore, timber, utilities, etc. For example, if given data item contains only a partial identification of a fuel usage rate, a determination may be made that an insufficient amount or type of data has been received to allow for further analysis. That is, a data management parameter 615 may be used to instruct the validation function 230 that the example fuel usage rate data must include particular types of values in order to retrieve similar data from the storage repository 620, 625, 630 for further validation and auditing.

If a determination is made for a given data item processed by the validation and auditing function 230 that enough and appropriate types of information have been received for the given data item, the data item may be audited by comparing the information to data provided by other suppliers according to similar processes. For example, if the LCI data item received by the validation and auditing function 230 is associated with labor used in crop production, the LCI data item may be compared with labor data provided by other suppliers in association with crop production.

After a received data item is validated as an appropriate life cycle inventory item, the data item may be audited for accuracy by the validation and auditing function 230. If a significant deviation exists between the received LCI data item and other similar product/process LCI data items, auditing may not proceed. As should be appreciated, deviation thresholds may be set for various types of products or components of products to aid in the analysis of whether received data does or does not deviate significantly from similar product/process LCI data. For example, toxicity levels associated with a given pesticide or fertilizer may exist in a certain range of toxicity levels for pesticides or fertilizers used in similar processes. If LCI data for a pesticide or fertilizer product is received showing a toxicity level outside the range of normal toxicity levels, then a determination may be made that the data deviates too significantly from similar data for similar products/processes, and the data item may be rejected as a valid LCI data item as described below.

If not enough information is received, or if inaccurate information is received such that the received data fails the validation operation, described above, or if the LCI data received deviates significantly from similar LCI data for similar products/processes (i.e., fails the auditing operation), then the data item may be rejected from use by other suppliers or from use in the generation of a life cycle impact assessment for the product to which the data item is associated. A data rejection/update notification 635 may be automatically provided to the supplier/provider of LCI data showing that the data received is insufficient, invalid, or is otherwise not acceptable. According to one embodiment, an automatic notification may be passed to the supplier/data provider to indicate those aspects of the received data that must be corrected or enhanced. For example, if a supplier provides usage data for hydroelectric power usage in terms of metric tons of usage as opposed to in terms of kilowatt-hours of usage, a notification may be provided to the supplier to correct the usage terms and to resubmit the LCI data.

Notifications may be made to the suppliers 110-155 via the data hub 105, and the notifications may be presented to the suppliers via the security framework 205. Such data item rejection notifications may be received, processed and responded to via the supplier computing device 160, as illustrated in FIG. 6. On the other hand, if the validated/audited data item is not rejected, it may be stored for provision to requesting suppliers via the security framework 205, and the data item may be used in the generation of a life cycle impact assessment for the product to which the data item is associated. As should be appreciated, each step of the validation and auditing process illustrated and described with reference to FIG. 6 may be accomplished by locating and passing data items from one processing step to another via the metadata and data structuring applied to LCI data items and managed, as described herein.

As illustrated above with respect to FIGS. 2A and 2B, components of the life cycle inventory and assessment data hub 105 include a data aggregation and scoring component 235, an auditing function 240, a data storage component 245 and a data release access component 250. As illustrated in FIG. 7, one or more subcomponents of the data aggregation and scoring component 235 are illustrated in association with other components of the data hub 105 utilized in association with the process of generating life cycle impact assessment scoring for a given product or for components of a given product based on one or more received life cycle inventory items associated with a given product.

The received product component 705 is illustrative of a given good and/or service for which a life cycle impact assessment is requested or required and for which life cycle inventory data is provided by a given supplier, as described above with reference to FIGS. 1-6. For example, the received product component 705 may be a complete product, for example, a cotton shirt for which the manufacturer requests a life cycle impact assessment, or the received product component may be a subcomponent or process, for example, a bale of cotton for use in making cotton shirts, or a cotton spinning process used for generating yarn or thread for making cotton fabrics. In either of these cases, the supplier of the received product component 705 may submit a variety of life cycle inventory (LCI) data for the product component 705 that may be validated, audited and stored for use in generating a life cycle impact assessment for the product component 705.

As will be described below, an LCIA score may be generated for the received product component by aggregating LCI data for the product or for components of the product from which an LCIA score may be generated. Or, the LCIA score may be generated for the received product component by aggregating LCIA scores generated for subcomponents or processes of or associated with the received product component from which a composite LCIA score may be generated for the product component 705.

The component metadata 710 is illustrative of metadata applied to received product component or to subcomponents or processes, as described above with reference to FIG. 5. The metadata 710 for the received product component 705 may be used by downstream processes associated with generating an LCIA score for the product component 705 by using the metadata 710 for searching and retrieving store LCI data and LCIA data for the received product component 705 or for subcomponents or processes of or associated with the product component 705.

The parser 715 is a software module operative to parse the component metadata 710 for using each individual data item (LCI or LCIA) 717, 719, 720 extracted from the received product via a search function 725 for obtaining information about individual data items including previously generated life cycle impact assessments for individual data items from the data repositories 525, 545, 565. As should be appreciated, when life cycle inventory data is provided by a given supplier, metadata applied to each individual data item may be used for finding similar data items that have previously been scored with a life cycle impact assessment scoring and for obtaining the previous scorings for similar data items for use in generating a life cycle impact assessment for the currently supplied data items. Alternatively, new life cycle impact assessments may be generated for each newly received life cycle inventory item, if required.

For example, if a product 705 provided by a supplier is the example bale of cotton, described herein, and one of the life cycle inventory items associated with production of the example bale of cotton includes the use of 100 hours of labor for production of the example bale of cotton, a life cycle inventory item of 100 hours per one bale of cotton may be tagged with an appropriate metadata item, and the tagged life cycle inventory item of 100 hours per bale of cotton may be passed to an appropriate storage repository 525, 545, 565 by the search function 725 to determine whether a life cycle impact assessment has previously been generated for the same life cycle inventory item. For example, if a previous submission of a labor item of 100 hours of labor per production of one bale of cotton has been assessed with a life cycle impact assessment of 75 on a scale of 0 to 100, then the life cycle impact assessment of 75 may be utilized for the newly received life cycle inventory item associated with the production of a bale of cotton. Alternatively, if a life cycle inventory item of 125 hours of labor for the production of a single bale of cotton is provided, and no matching item with a previously generated life cycle impact assessment is stored in a storage repository 525, then a life cycle impact assessment for the labor inventory item will be generated for the presently provided product and for use in generating life cycle impact assessment scoring for future product submissions.

The life cycle impact assessment and scoring engine 730 is illustrative of a software application or module containing sufficient computer executable instructions operative to generate life cycle impact assessments and life cycle assessment scores for various life cycle inventory items and for generating composite life cycle impact assessments and life cycle assessment scores for goods and/or services comprised of or utilizing various components or services for which life cycle impact assessments and life cycle assessment scores previously have been generated. For example, if a product is provided by a supplier comprised of ten components, for example, all components required for the production of a single bale of cotton, and if life cycle impact assessments previously have been generated for each of the same components, then the life cycle impact assessment and scoring engine 730 may obtain and aggregate each of the individual LCIAs for each of the individual components/processes for generating a composite LCIA and eventually an LCIA score.

As described above, life cycle assessments (LCIAs) may be generated by the engine 730 based on scientifically verified and standardized algorithms for determining impacts on various environmental and/or social categories, such as global warming, acidification, child labor and the like. On the other hand, LCIA scoring may be generated by the engine 730 based on weightings applied to LCIAs according to a variety of scoring algorithms that may differ greatly depending on the values applied to each impact category by different scoring bodies.

Alternatively, if no LCIA or LCIA score has been generated for a given component or process associated with a provided set of life cycle inventory items associated with a provided product, then the engine 730 is operative to generate a life cycle impact assessments and LCIA scores for life cycle inventory items for which no life cycle impact assessment has been generated. For example, if a life cycle impact assessment for a global warming impact category associated with a given fuel is a 75 on a scale of 0 to 100 for a consumption rate of ten gallons per hour, but a life cycle impact assessment of 50 has been generated and stored for the same fuel item associated with a consumption rate of 20 gallons per hour, then if a life cycle inventory item for the same fuel associated with a consumption rate of 15 gallons per hour is submitted, the engine 730 may generate an LCIA for the newly provided LCI item of 62.5 which is the arithmetic mean of the previously generated LCIA numbers. As should be appreciated, a variety of methods may be used by the LCIA scoring engine for determining and generating LCIA scores for individual LCI data items. For example, a scale of LCIA scores for various raw materials, energy usages, labor statistics, and the like may be maintained by one or more government and/or regulatory bodies and may be used by the LCIA scoring engine.

Other LCIA scoring values associated with various materials, energy usages, and processes may be generated through extensive testing by independent testing agencies or bodies. Such LCIA assessment scores may be stored by data type in the data storage repositories 525, 545, 565, and the search function 725 may utilize metadata associated with received life cycle inventory items for a provided product to locate life cycle impact assessment data for individual items for use by the LCIA scoring engine 730 in generating an LCIA score for a provided product.

After LCIAs are generated for a given product, the LCIAs may be aggregated for auditing and review. In addition, any LCIA scoring generated for products or components of products likewise may be aggregated for audit and review. Aggregated LCIAs and/or LCIA scoring may be passed to the auditing function 240 for analysis.

After LCIAs and any LCIA scores are generated by the LCIA impact and scoring engine 730, an auditing function 240, described above with reference to FIG. 2 may be employed for auditing the LCIAs generated for the received product 705. For example, the LCIAs generated for the received product may be compared with LCIAs generated for similar products to determine whether the generated LCIAs appear to be out of range in comparison to LCIAs generated for other similar products. For example, if the typical LCIA for a global warming impact category for the generation of a bale of cotton is between 50 and 80 on a scale of 0 to 100 and if an LCIA of 30 is generated for the LCI data for a newly produced bale of cotton, then the auditing function 240 may determine as part of a review function 740 that life cycle inventory data items presented for the example bale of cotton are inaccurate or otherwise invalid. In such cases, in the same manner as described above with reference to FIG. 6, such an LCIA may be rejected, and the product supplier may be notified to allow the product supplier to review the provided LCI data and to update the LCI data as necessary.

Referring still to FIG. 7, LCIAs and LCIA scores generated by the LCIA impact and scoring engine 730 that are determined to be appropriate LCIAs and LCIA scores for a given product may be stored by the LCIA impact and score storing function 245 in a data storage repository 525, 545, 565. Alternatively, metadata associated with generated LCIAs and LCIA scores may be stored in the data repositories 525, 545, 565 for use in locating LCIAs and LCIA scores that are stored remotely from the data storage repositories 525, 545, 565. In addition, the LCIAs and LCIA scores generated for the received product component 705 may be used subsequently in the generation of a composite LCIAs and LCIA scores 750 as part of a downstream production or process utilizing the received product 705 as a component. For example, LCIAs generated for a bale of cotton may be utilized in the generation of a composite or aggregated LCIA or LCIA score for the production of cotton shirts from bales of cotton.

Once LCIAs and any LCIA scoring are generated for a given product, a reporting function 745 may be implemented, wherein LCIAs and LCIA scoring may be released to one or more requesting suppliers via the data release access point 250, illustrated and described above with reference to FIGS. 2A, 2B. According to one embodiment, the release of LCIAs and LCIA scoring data may be performed automatically to the provider of the product component 705 or to suppliers of subcomponents and/or processes associated with the provided component. For example, all suppliers of components or processes associated with the production of a cotton shirt may receive automatic notifications of LCIAs and LCIA scores generated for their respective components or processes and for other components or processes required for the production of the final product. Such suppliers may also automatically receive the LCIAs and LCIA scores aggregated for combinations of components or processes or aggregated for the final product.

In addition, as individual LCI data items associated with the received product component 705 or for subcomponent or processes associated with the product component 705 are changed or are otherwise revised by their respective suppliers, the LCIAs and LCIA scores that were generated based on those LCI data items, may be automatically updated based on LCIAs and LCIA scoring applied to the changed or otherwise revised LCI data items. Updated LCIAs and LCIA scores may be automatically published to appropriate requesters/receivers of the LCIAs and LCIA scores, as described above.

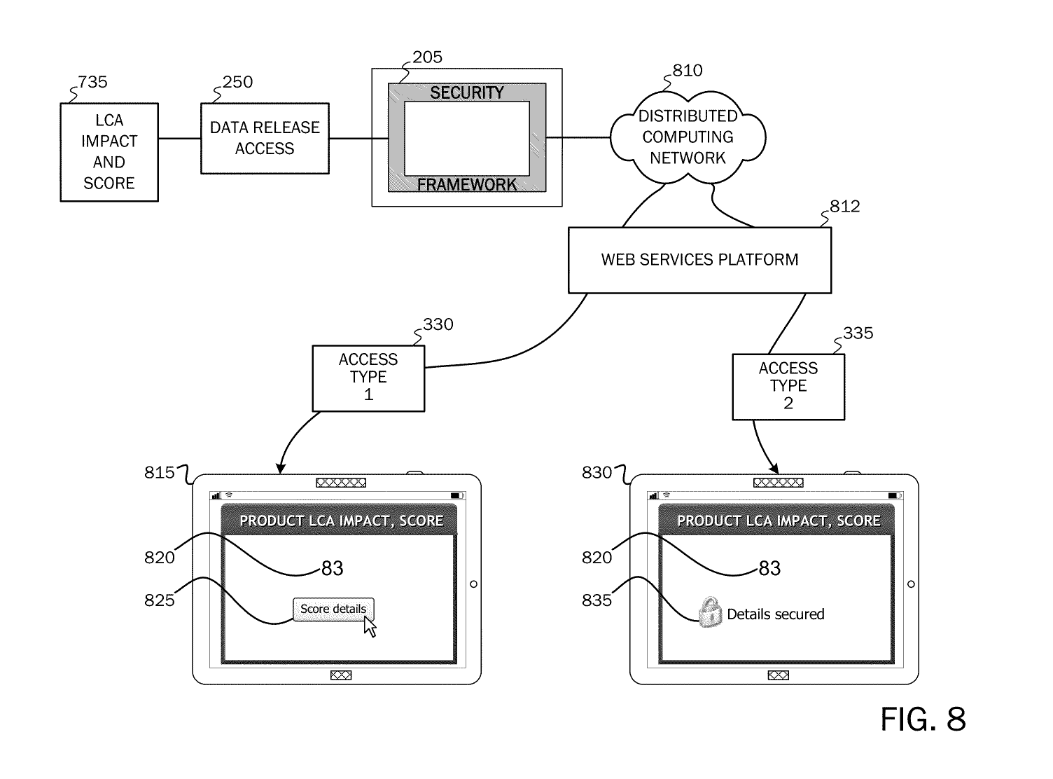

As described above, life cycle inventory data, life cycle impact assessments and life cycle assessment scoring data may be released to requesting parties for use in the production of their goods and/or services or for publication in association with goods and/or services, as described below. That is, individual life cycle inventory items that have been validated and audited and found acceptable, as described above may be released to one or more requesting parties, and life cycle impact assessments and scoring for one or more products or services may be released to requesting parties for use in generating downstream products or for publication in association with a given product. Referring to FIG. 8, LCIAs and LCIA scores 735 (or, an individual LCI data item) may be released to requesting parties via the data release access point 250, illustrated with reference to FIGS. 2A,2B through the security framework 205.

According to an embodiment, requesting parties may access LCI data, LCIAs and LCIA scoring via the security framework from one or more computing devices 815, 830 through a distributed computing network 810, such as the Internet or an intranet. Access to the LCI data, LCIAs and LCIA scoring data generated and stored by the life cycle inventory and assessment data hub 105 may be accessed through a variety of available access portals, for example, a secure web access portal provided in association with the security framework 205. For example, each requesting party may launch a web page provided in association with the data hub 105 for both entering LCI data, LCIAs and LCIA scoring data, and for requesting LCI data, LCIAs and LCIA scoring data.

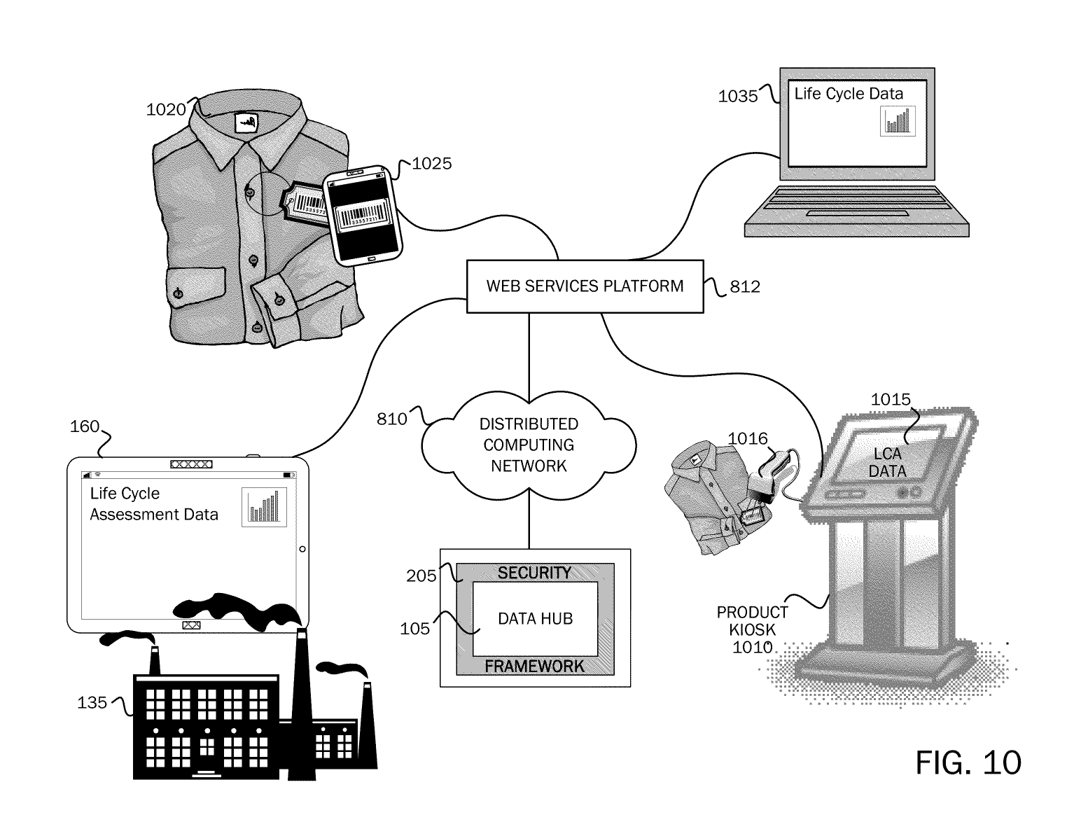

A web services platform 812 is illustrated for allowing a variety of end users, for example, the suppliers 110-155, illustrated above with reference to FIG. 1, end use consumers, regulatory agencies, and the like to access LCI data and LCIAs and scoring data associated with one or more products or components of one or more products. According to one embodiment, the web services platform 812 is operative to provide web page-type interfaces with which accessing parties may access the functionality described herein for requesting LCI and LCIA data, for submitting LCI and LCIA data for further analysis and further generation of additional LCIA scoring, for submitting updates to previously submitted LCI data, and the like. Interaction between external users and the LCI/LCIA functionality of the data hub 105 is described in further detail below with references to FIGS. 10-14.

As illustrated in FIG. 8, and as described above with reference to FIG. 3, each requesting party may be assigned one or more access types for dictating the amounts and types of information the requesting parties may receive. For example, first requesting party using the computing device 815 is associated with a first access type 330 that allows the requesting party to receive LCIAs and LCIA scoring data 820 for a given product and to receive LCIAs and LCIA scoring data details 825. According to an embodiment, the scoring details 825 may provide the requesting party with detailed information on how the LCIAs and LCIA scoring data were developed including detailed information on scoring applied to various components of the associated product including LCI data associated with the various components.

On the other hand, if the second requesting party using the computing device 830 receives a second access type that precludes the second requesting party from receiving detailed information about the received LCIAs and LCIA scoring data, the details may be secured from access by the second requesting party to prevent the second requesting party from learning of the details of the generation of the LCIAs and LCIA scoring data for the subject product. For example, if the components of the product for which the LCIAs and LCIA scoring data is provided are proprietary in nature, for example, where the precise combination of components is a trade secret of the manufacturer of the subject product, then the access provided to the second requesting party may allow the second requesting party to receive the LCIAs and LCIA scoring data for the product, but may preclude the second requesting party from receiving detailed information on the components of the subject product. For another example, the second requesting party may be precluded from access to information about constituent components of the product to prevent the second requesting party from contacting providers of the constituent components to gain a competitive advantage over the provider of the product for which the LCIAs and LCIA scoring data is provided. In addition to reporting LCIAs and LCIA scoring data, information on algorithms and data weightings used in the generation of LCIAs and LCIA scoring data may be provided.

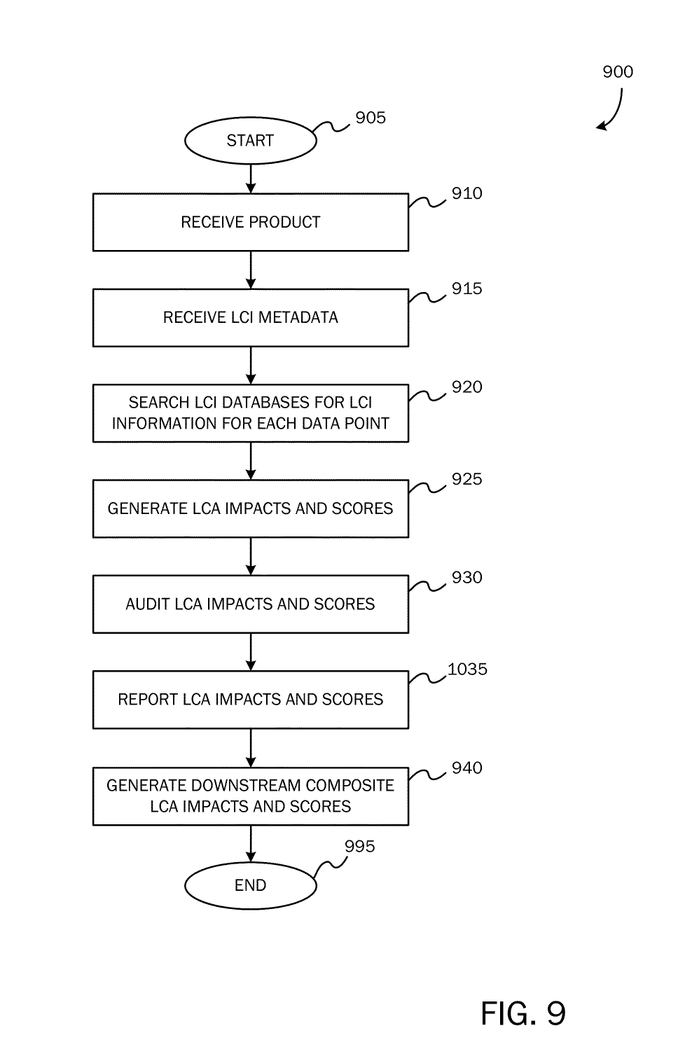

Having described a system architecture for and various aspects of the generation and provision of life cycle impact assessments for various goods and/or services, FIG. 9 is a flowchart illustrating a method for aggregating life cycle inventory and assessment data and for generating life cycle impact assessment scoring for a good and/or service. The routine 900 begins at start operation 905 and proceeds to operation 910 where a product is presented by a product supplier for receiving a generated life cycle impact assessment for the presented product. At operation 915, metadata associated with the presented product is parsed from a structured data template provided for the received product. At operation 920, LCI databases are searched for LCI information for each data point associated with the received product.

At operation 925, LCI inventory items are searched, and LCIAs and LCIA scoring associated with the LCI inventory items are retrieved for generation of LCIAs and LCIA scoring for the received product. The aggregation of LCIAs and LCIA scoring data for individual LCI items may be accomplished according to a variety of methods, as described above. At operation 925, LCIAs and LCIA scoring may be generated for the received product. At operation 930, the generated LCIAs and LCIA scoring may be audited to determine whether the generated LCIAs and LCIA scoring is accurate in comparison to a range of LCIAs and LCIA scoring generated for similar products in the past. As any LCI or LCIA data associated with the received product is changed or otherwise revised, the LCIAs and any generated LCIA scores for the received product may be automatically updated and released and/or published, as required based on product changes or versioning information for the product, as described above.

At operation 935, the LCIAs and LCIA scoring generated for the received product may be reported to requesting parties, as described above with reference to FIG. 8, and the LCIAs and LCIA scoring may be published according to a variety of means, as described herein. At operation 940, downstream composite LCIAs and LCIA scoring may be generated for products comprised of component products for which LCIAs and LCIA scoring have been generated. The routine 900 ends at operation 995.

FIG. 10 is a simplified block diagram illustrating a system architecture for allowing one or more providers or users of LCI and LCIA data to interact with LCI/LCIA data and LCI/LCIA data processing functionality via a web services platform. As described above with reference to FIG. 8, providers of LCI and LCIA data and users of LCI and LCIA data, including users engaged in manufacturing, processing, using, and/or disposing of goods and/or services, and including end use consumers of goods and/or services may access the data hub 105 through the security framework 205 for providing LCI and LCIA data and for obtaining LCI and LCIA data in accordance with access privileges provided to each accessing party.

As mentioned above, the web services platform 812 provides an Internet-based interface for allowing various parties to access the LCI and LCIA data for both providing such data and for obtaining such data from any disparate location and through a variety of useful means. For example, one of the suppliers 110-155, illustrated in FIG. 1, for example, the factory 135, may access the data stores and functionality of the data hub 105 through the web services platform 812, as described below. In addition, an end user, for example, an end user consumer of goods or services may access the LCI and LCIA data and associated functionality from an end user computer 1035 through the web services platform 812. For example, an end user may wish to research the LCI scores associated with various products from her home computer 1035 in order to assist the user in making purchasing decisions regarding various articles of purchase.

Referring still to FIG. 10, a mobile computing device 1025, for example, a smart phone, is illustrated with which a user may photograph or scan a bar code affixed to a good 1020, for example, an article of clothing or other article of purchase to allow the user to interact with the web services platform 812 for obtaining LCIA impact assessments and LCIA scoring for the example article 1020. That is, by scanning an identifying mark, such as a bar code, serial number or the like using the mobile device 1025, the user may transmit the scanned or photographed information to the data hub 105 through the web services platform 812 for requesting LCIA impact assessments and LCIA scoring information for the subject article 1020.

The kiosk 1010 having a display screen 1015 is illustrative of a kiosk that may be positioned at a wholesale or retail shopping location, for example, a shopping mall, department store, and the like to allow users to obtain LCIA information on various products. The kiosk also includes a scanner 1016 to allow users to scan bar codes or other identifying markings placed on labels of goods in the same manner as using the mobile computing device 1025. Thus, using the kiosk 1010, an end user consumer of goods and/or services may request LCIA impact assessments and LCIA scoring information on a variety of products or services to allow the users to make informed purchase and use decisions with respect to prospective goods and/or services.

FIG. 11 is a simplified block diagram of a web-based interface with which a supplier or consumer may provide LCI and LCIA data and with which a supplier or consumer may request LCI and LCIA data. The life cycle assessment interface 1105 illustrated in FIG. 11 is a web page-based interface that may be provided to one or more accessing suppliers for allowing suppliers to enter LCI data items for beginning the process of obtaining life cycle impact assessments (LCIA) or scores for one or more products or product components. As should be appreciated, the life cycle assessment interface 1105 may be launched via one of the computing devices/interfaces illustrated and described above with reference to FIG. 10 via the web services platform 812 for allowing the supplier or user to access the interface 1105 from the data hub 105 through the security framework 205. As should be appreciated, as described herein, when a user attempts to access and display the life cycle assessment interface 1105, the user may be provided a dialog box with which he/she may be required to enter one or more authentication credentials, for example, a password, for obtaining access to the LCDI/functionality, including receiving a display of life cycle assessment interface 1105, illustrated in FIG. 11.

Referring still to FIG. 11, the product entry field 1110 and the product code field 1115 may be used by an accessing supplier or end user for entering a description of a given product for obtaining LCI and/or LCIA data or scoring for a given product. The product code field 1115 may allow a user to select from a drop down menu codes associated with various products, for example, codes associated with articles of clothing, appliances, automobiles, and the like for further refining a search in association with a search string entered into the text field 1110.

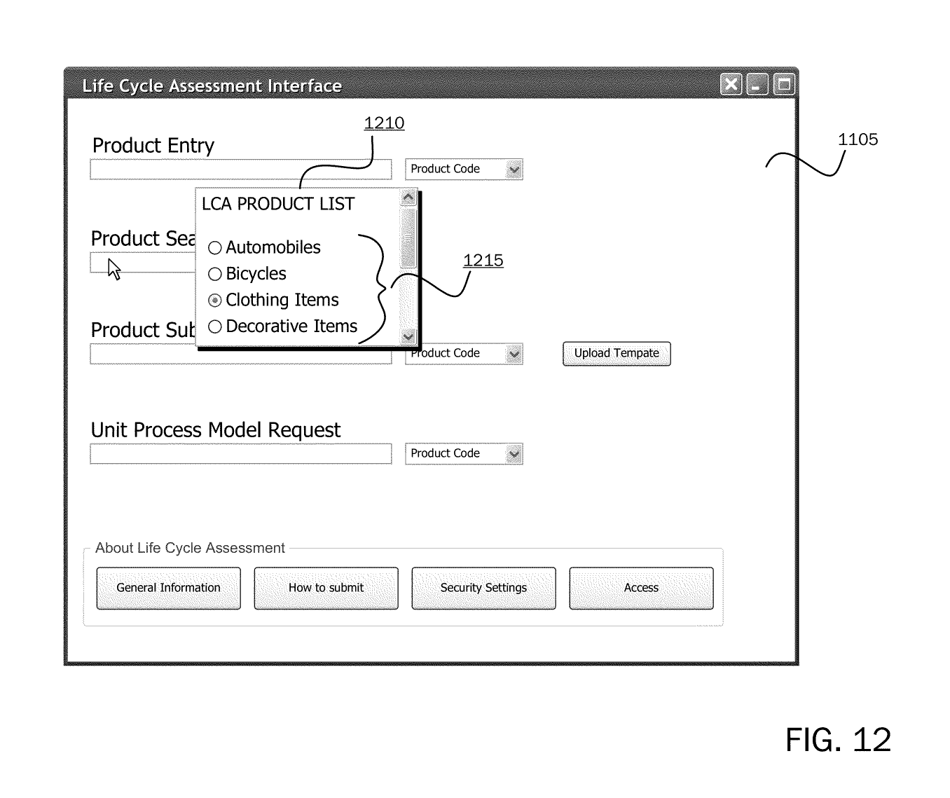

If a requesting supplier or end user does not have a particular product in mind or does not know a product code for a particular product, the product search interface 1120 may be used for entering a search string for obtaining a list of product types with which a user may select one or more items for commencing an LCI and/or LCIA data search. An example product list responsive to a search via the product search interface 1120 is illustrated and described below with reference to FIG. 12.

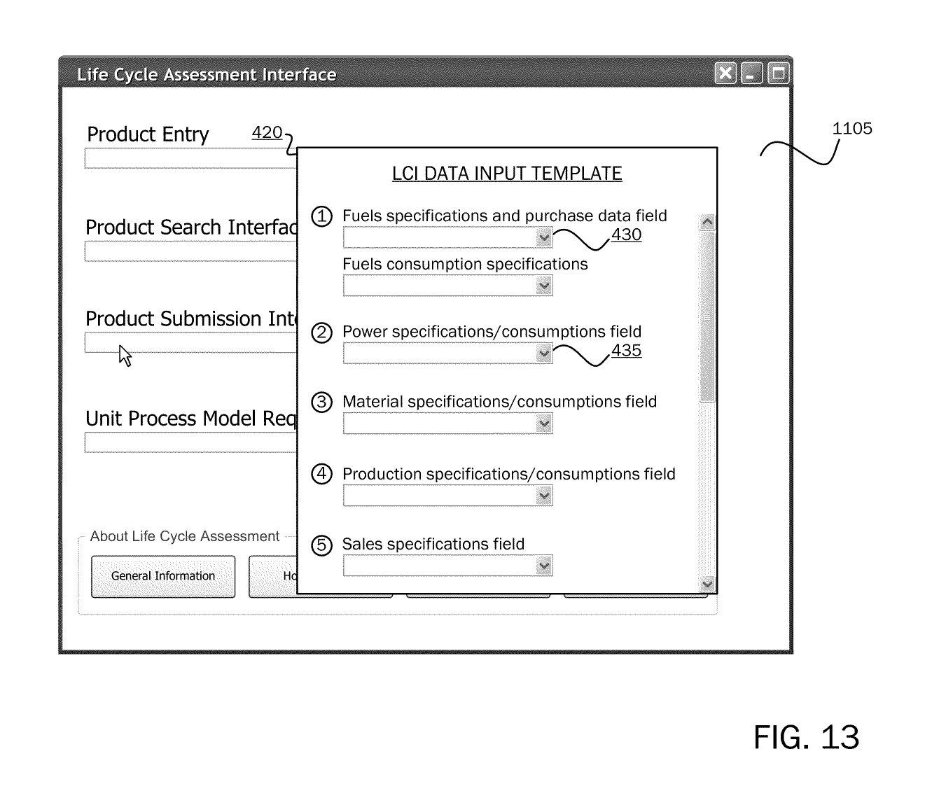

As described above, suppliers 110-155 may enter LCI data for obtaining validation, auditing and LCIA impact assessments and LCIA scoring generation through various means. If the supplier is capable of submitting a full LCI data set via a structured data template 420, illustrated above with reference to FIG. 4, identification information for the product may be entered in the product submission interface 1125, a product code may be selected from the product code interface 1130, and an upload template function or control 1135 may be selected for launching a structured data template 420, as illustrated below with reference to FIG. 13, for allowing the supplier to enter the LCI data items for submission, as described herein.

Where a supplier 110-155 is not capable of submitting the structured data template 420, the supplier may request a unit process model associated with a given product type for obtaining a generic template with which the supplier may enter LCI data that may be structured for the supplier by the functionality of the data hub 105, as described above. Identification of the product and product type information may be entered in the unit process model request field 1140 and the product type field 1145, respectively.

Referring still to FIG. 11, a variety of functionality controls 1150, 1155, 1160, 1165 are illustrated for allowing users to obtain information about the life cycle assessment process. For example, a “General Information” function allows for a provision of general information about the life cycle assessment process, described herein. A “How to Submit” function 1155 allows suppliers and end users to receive help content on how to submit LCI data for generation of life cycle assessment scores. The “Security Settings” function 1160 may allow suppliers and/or end users to obtain or modify privileges for allowing the suppliers and/or end users to interact with the life cycle assessment system via the data hub 105 according to different access types. The “Access” function 1165 may allow suppliers and/or users to access the data hub 105 for interacting with the LCI and LCIA data, as described herein.

As illustrated in FIG. 12, an LCIA product list 1210 is provided in response to a product search entered into the product search interface 1120, illustrated in FIG. 11. For example, if a supplier or end user enters a generic text string such as “consumer products,” an LCIA product list 1210 may be provided showing various consumer products for which the user may obtain LCIA information to assist the user in use and/or purchase decisions about one or more goods and/or services.

As illustrated in FIG. 13, in response to interaction with the product submission interface 1125, the structured data template 420, illustrated and described above with reference to FIG. 4, may be provided to allow a user to enter detailed LCI data for receiving validation and/or auditing of the LCI data and for receiving LCIA impact assessments and LCIA scoring in association with the LCI data.

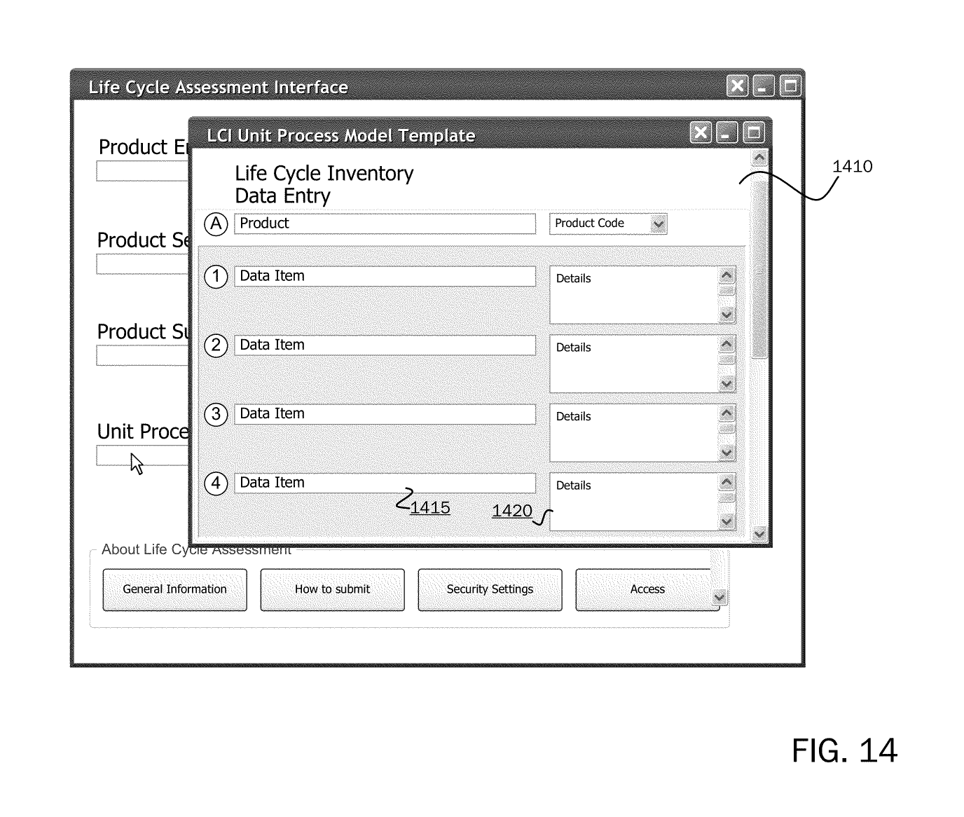

As illustrated in FIG. 14, a generic LCI template 1410 is provided in response to a unit process model request. That is, the unit process model template 1410, illustrated in FIG. 14, may allow a user to enter life cycle inventory data along with various details associated with the life cycle inventory data for submission to the data hub 105. As described above, at the data hub 105, information entered by the supplier via the unit process template 1410 may be annotated with one or more metadata items and may be structured according to a structured data language for allowing the received LCI data to be processed, as described herein.

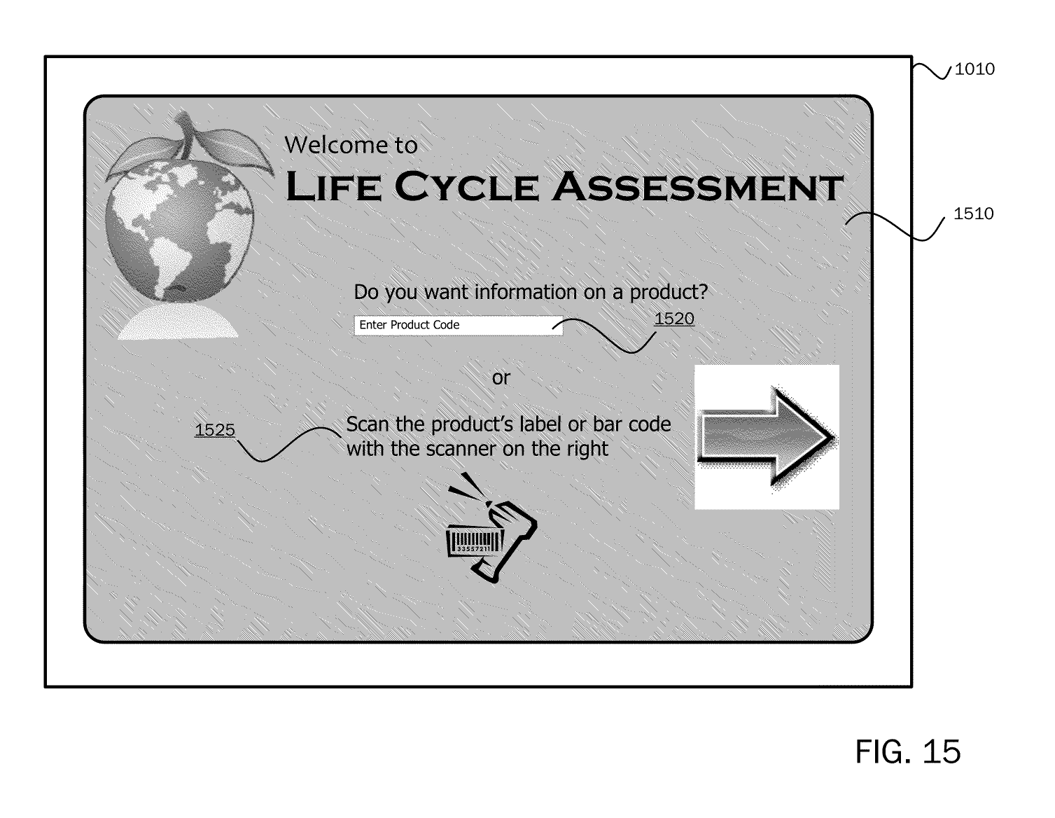

Referring now to FIG. 15, a user-friendly interface is illustrated as an example web-based interface that may be provided to end user consumers via end user mobile and stationary computing devices 1025, 1035, 1010, described above with reference to FIG. 10. For example, if a consumer uses the product kiosk 1010, illustrated in FIG. 10, for obtaining LCIA impact assessments and LCIA scoring information on a product, a user-friendly web interface 1510 may be presented. A product code field 1520 is provided to allow a user to enter a product code from a label or other identifying information affixed to or associated with the product, or the user may be invited through an invitation string 1525 to scan a label, bar code, or other identifying marking affixed to or associated with a product using a scanner. In either case, once the user submits identifying information for a given product, the user may receive LCIA impact assessments and LCIA scoring information for the product along with information on what LCIA impact assessments and LCIA scoring means, and how the user may utilize LCIA impact assessments and LCIA scoring information to assist the user in making an informed purchase decision.

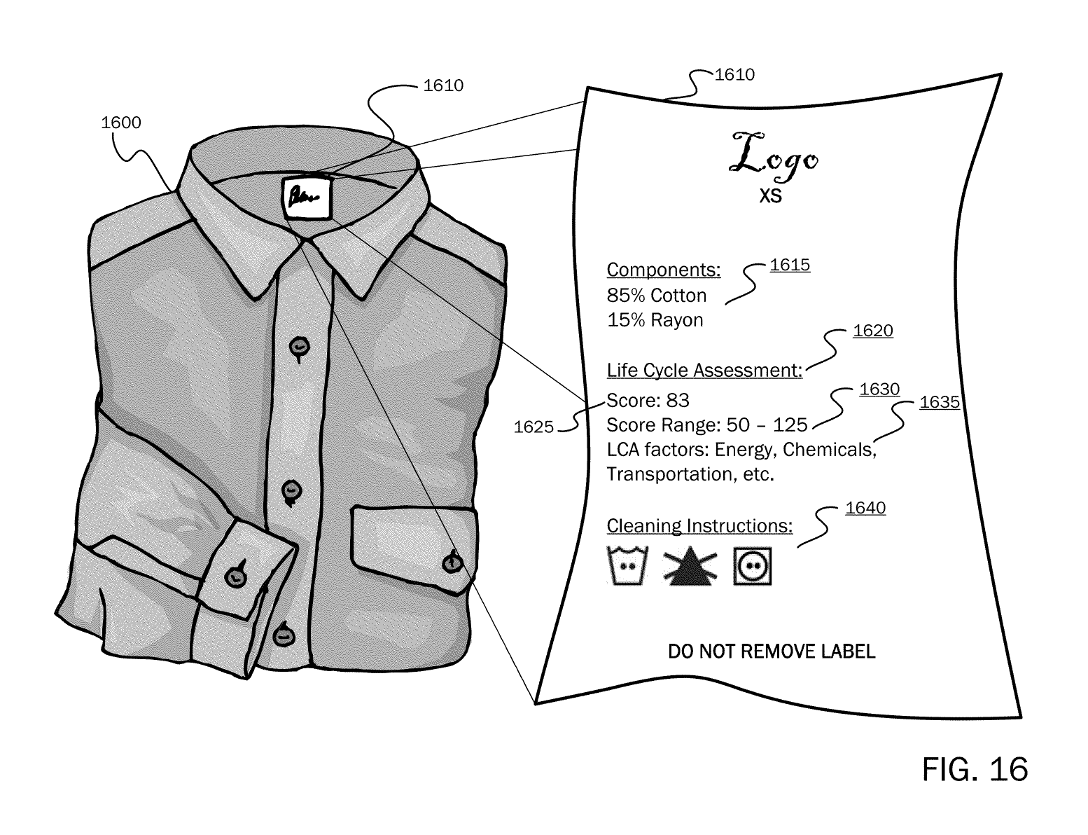

Referring now to FIG. 16, LCIA impact assessments and/or LCIA scores for a given product may be published in association with the product to allow consumers of the product to review the LCIA impact assessments and/or LCIA scores as desired. For example, an LCIA assessment or score may be published in specification literature associated with a given product, an LCIA score may be published in Internet-based marketing materials for a given product, LCIA impact assessments and LCIA scoring may be published as part of a material safety data sheet associated with a given product or component, and the like. As illustrated in FIG. 16, an LCIA impact assessment or score is published on a label of an example article of clothing to allow consumers of the article of clothing to review the LCIA impact assessment or score as part of purchasing decisions with respect to the example article of clothing.

As illustrated in FIG. 16, the label 1610 of an example cotton shirt includes various information such as components information 1615 identifying the components of the article of clothing and cleaning instructions information 1640 indicating the proper methods for cleaning the article of clothing. According to embodiments of the present invention, life cycle assessment data 1620 is also provided on the example label 1610. Under the life cycle assessment heading 1620, a life cycle assessment score 1625 is presented showing an example score of 83. Beneath the LCIA impact assessment or score 1625 is an LCIA impact assessment or score range 1630 showing an example LCIA score range of 50 to 125. Factors included in the generation of the LCIA impact assessment or score for the example article of clothing are also provided showing that factors included in the generation of the score included energy, chemicals, transportation, etc.

As should be appreciated, a prospective purchaser of the example article of clothing may review the life cycle assessment score provided with the article of clothing to compare the score provided with this article of clothing with scores provided by other similar articles of clothing to allow the purchaser to make an informed judgment as to which article of clothing is more desirable in terms of environmental and social impact associated with its manufacture, distribution, sale, use, and eventual disposal. As should be appreciated, the information illustrated in the example label 1610 is for purposes of example only and is not limiting of the exhaustive amounts of information that may be provided for a given product, including additional detailed information about the generation and publication of a life cycle assessment score.

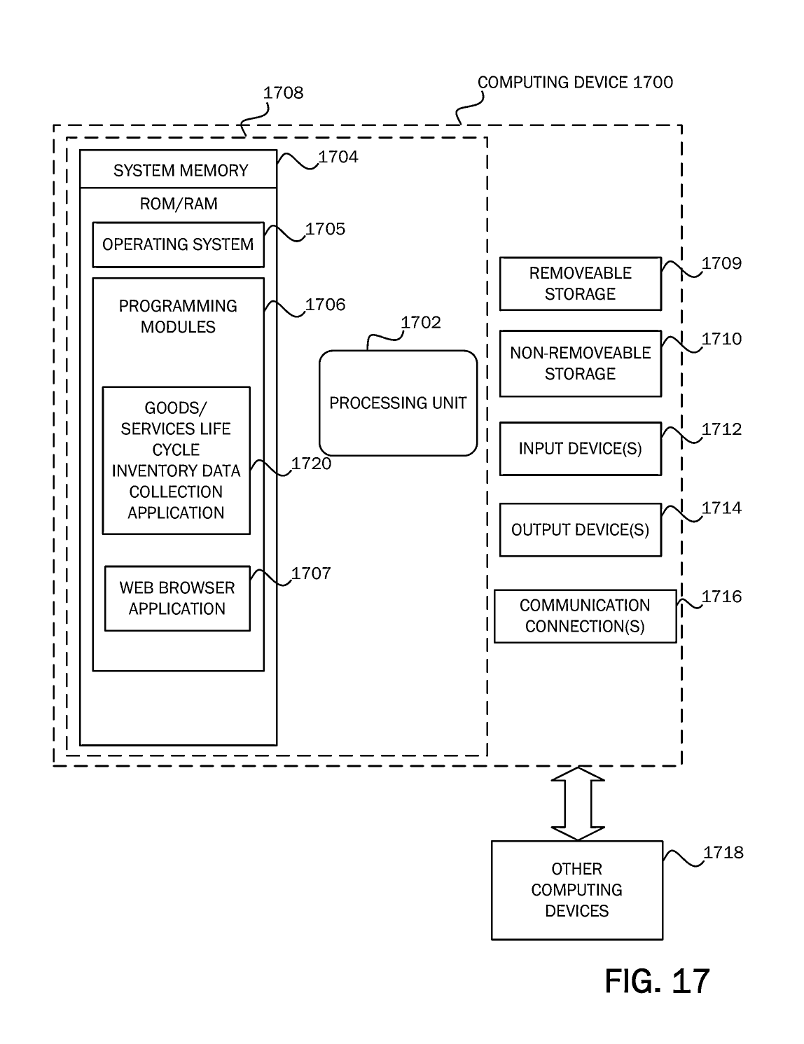

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 17-19 and the associated descriptions provide a discussion of a variety of operating environments in which embodiments of the invention may be practiced. However, the devices and systems illustrated and discussed with respect to FIGS. 17-19 are for purposes of example and illustration and are not limiting of a vast number of computing device configurations that may be utilized for practicing embodiments of the invention, described herein.

FIG. 17 is a block diagram illustrating example physical components of a computing device 1700 with which embodiments of the invention may be practiced. The computing device components described below may be suitable for the computing devices described above, for example, the computing device 160, 815, 830. In a basic configuration, computing device 1700 may include at least one processing unit 1702 and a system memory 1704. Depending on the configuration and type of computing device, system memory 1704 may comprise, but is not limited to, volatile (e.g. random access memory (RAM)), non-volatile (e.g. read-only memory (ROM)), flash memory, or any combination. System memory 1704 may include operating system 1705, one or more programming modules 1706, and may include the comments application 1720. Operating system 1705, for example, may be suitable for controlling computing device 1700's operation. Furthermore, embodiments of the invention may be practiced in conjunction with a graphics library, other operating systems, or any other application program and is not limited to any particular application or system. This basic configuration is illustrated in FIG. 17 by those components within a dashed line 1708.

Computing device 1700 may have additional features or functionality. For example, computing device 1700 may also include additional data storage devices (removable and/or non-removable) such as, for example, magnetic disks, optical disks, or tape. Such additional storage is illustrated in FIG. 17 by a removable storage 1709 and a non-removable storage 1710.

As stated above, a number of program modules and data files may be stored in system memory 1704, including operating system 1705. While executing on processing unit 1702, programming modules 1706, such as the life cycle inventory and assessment application 1720 may perform processes including, for example, one or more of the stages of method 900. The aforementioned process is an example, and processing unit 1702 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 17 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the life cycle inventory and assessment application 1720 may be operated via application-specific logic integrated with other components of the computing device/system 1700 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1704, removable storage 1709, and non-removable storage 1710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1700. Any such computer storage media may be part of device 1700. Computing device 1700 may also have input device(s) 1712 such as a keyboard, a mouse, a pen, a sound input device, a touch input device, etc. Output device(s) 1714 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

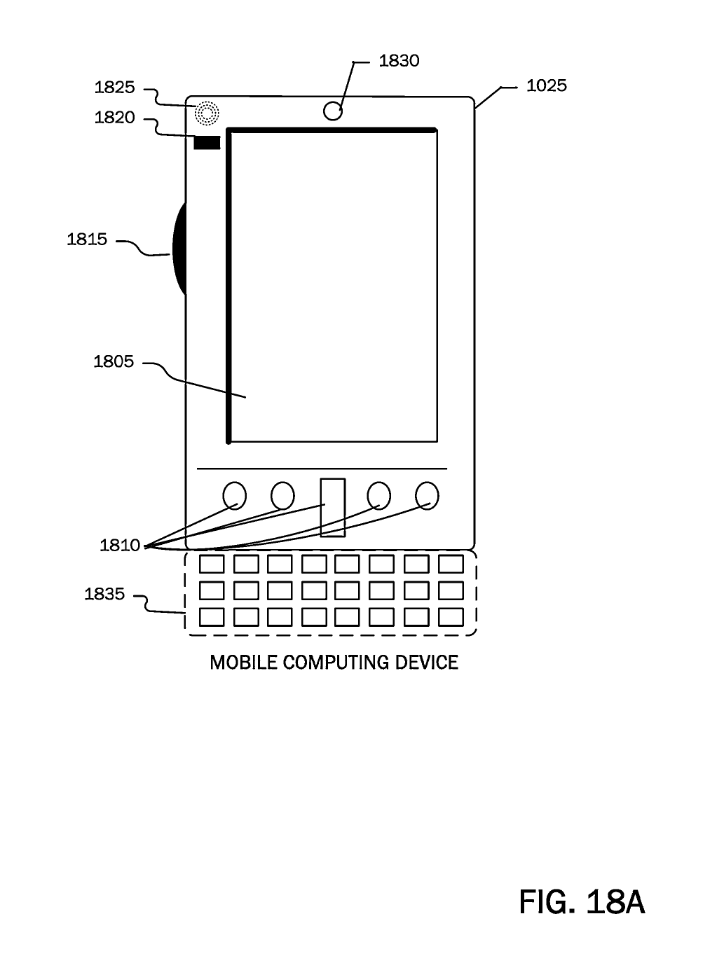

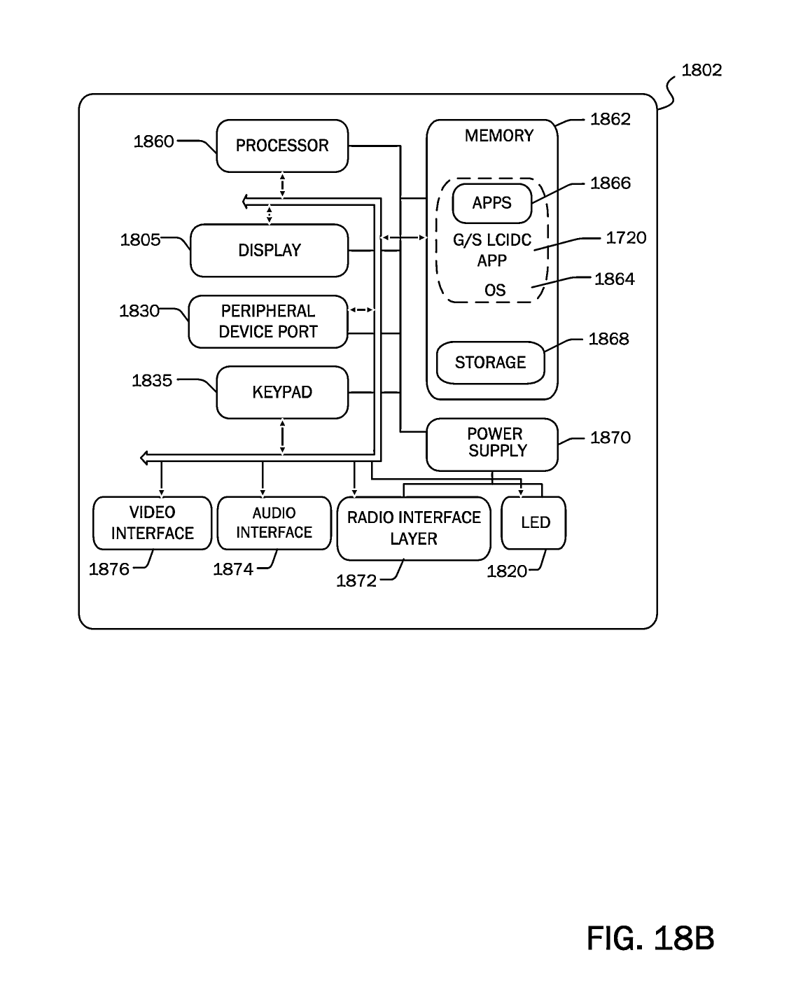

FIGS. 18A and 18B illustrate a suitable mobile computing environment, for example, a mobile telephone 1025, a smart phone, a tablet personal computer, a laptop computer, and the like, with which embodiments of the invention may be practiced. With reference to FIG. 18A, an example mobile computing device 1800 for implementing the embodiments is illustrated. In a basic configuration, mobile computing device 1800 is a handheld computer having both input elements and output elements. Input elements may include touch screen display 1805 and input buttons 1815 that allow the user to enter information into mobile computing device 1800. Mobile computing device 1800 may also incorporate an optional side input element 1815 allowing further user input. Optional side input element 1815 may be a rotary switch, a button, or any other type of manual input element. In alternative embodiments, mobile computing device 1800 may incorporate more or less input elements. For example, display 1805 may not be a touch screen in some embodiments. In yet another alternative embodiment, the mobile computing device is a portable phone system, such as a cellular phone having display 1805 and input buttons 1815. Mobile computing device 1800 may also include an optional keypad 1835. Optional keypad 1815 may be a physical keypad or a “soft” keypad generated on the touch screen display.

Mobile computing device 1800 incorporates output elements, such as display 1805, which can display a graphical user interface (GUI). Other output elements include speaker 1825 and LED light 1820. Additionally, mobile computing device 1800 may incorporate a vibration module (not shown), which causes mobile computing device 1800 to vibrate to notify the user of an event. In yet another embodiment, mobile computing device 1800 may incorporate a headphone jack (not shown) for providing another means of providing output signals.

Although described herein in combination with mobile computing device 1800, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 18B is a block diagram illustrating components of a mobile computing device used in one embodiment, such as the computing device shown in FIG. 18A. That is, mobile computing device 1025 can incorporate system 1802 to implement some embodiments. For example, system 1802 can be used in implementing a “smart phone” that can run one or more applications similar to those of a desktop or notebook computer such as, for example, browser, e-mail, scheduling, instant messaging, and media player applications. In some embodiments, system 1802 is integrated as a computing device, such as an integrated personal digital assistant (PDA) and wireless phone.

One or more application programs 1866 may be loaded into memory 1862 and run on or in association with operating system 1864. Examples of application programs include phone dialer programs, e-mail programs, PIM (personal information management) programs, word processing programs, spreadsheet programs, Internet browser programs, messaging programs, and so forth. System 1802 also includes non-volatile storage 1868 within memory 1862. Non-volatile storage 1868 may be used to store persistent information that should not be lost if system 1802 is powered down. Applications 1866 may use and store information in non-volatile storage 1868, such as e-mail or other messages used by an e-mail application, and the like. A synchronization application (not shown) also resides on system 1802 and is programmed to interact with a corresponding synchronization application resident on a host computer to keep the information stored in non-volatile storage 1868 synchronized with corresponding information stored at the host computer. As should be appreciated, other applications may be loaded into memory 1862 and run on the device 1800, including the life cycle inventory and assessment application 1720, described herein.

System 1802 has a power supply 1870, which may be implemented as one or more batteries. Power supply 1870 might further include an external power source, such as an AC adapter or a powered docking cradle that supplements or recharges the batteries.

System 1802 may also include a radio 1872 that performs the function of transmitting and receiving radio frequency communications. Radio 1872 facilitates wireless connectivity between system 1802 and the “outside world”, via a communications carrier or service provider. Transmissions to and from radio 1872 are conducted under control of OS 1864. In other words, communications received by radio 1872 may be disseminated to application programs 1866 via OS 1864, and vice versa.

Radio 1872 allows system 1802 to communicate with other computing devices, such as over a network. Radio 1872 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 1802 is shown with two types of notification output devices; LED 1820 that can be used to provide visual notifications and an audio interface 1874 that can be used with speaker 1825 to provide audio notifications. These devices may be directly coupled to power supply 1870 so that when activated, they remain on for a duration dictated by the notification mechanism even though processor 1860 and other components might shut down for conserving battery power. LED 1820 may be programmed to remain on indefinitely until the user takes action to indicate the powered-on status of the device. Audio interface 1874 is used to provide audible signals to and receive audible signals from the user. For example, in addition to being coupled to speaker 1825, audio interface 1874 may also be coupled to a microphone to receive audible input, such as to facilitate a telephone conversation. In accordance with embodiments of the present invention, the microphone 1720 may also serve as an audio sensor to facilitate control of notifications, as will be described below. System 1802 may further include video interface 1876 that enables an operation of on-board camera 1830 to record still images, video stream, and the like.

A mobile computing device implementing system 1802 may have additional features or functionality. For example, the device may also include additional data storage devices (removable and/or non-removable) such as, magnetic disks, optical disks, or tape. Such additional storage is illustrated in FIG. 18B by storage 1868. Computer storage media may include volatile and nonvolatile, removable and non-removable media implemented in any method or technology for storage of information, such as computer readable instructions, data structures, program modules, or other data.

Data/information generated or captured by the device 1025 and stored via the system 1802 may be stored locally on the device 1025, as described above, or the data may be stored on any number of storage media that may be accessed by the device via the radio 1872 or via a wired connection between the device 1025 and a separate computing device associated with the device 1025, for example, a server computer in a distributed computing network, such as the Internet. As should be appreciated such data/information may be accessed via the device 1025 via the radio 1872 or via a distributed computing network. Similarly, such data/information may be readily transferred between computing devices for storage and use according to well-known data/information transfer and storage means, including electronic mail and collaborative data/information sharing systems.

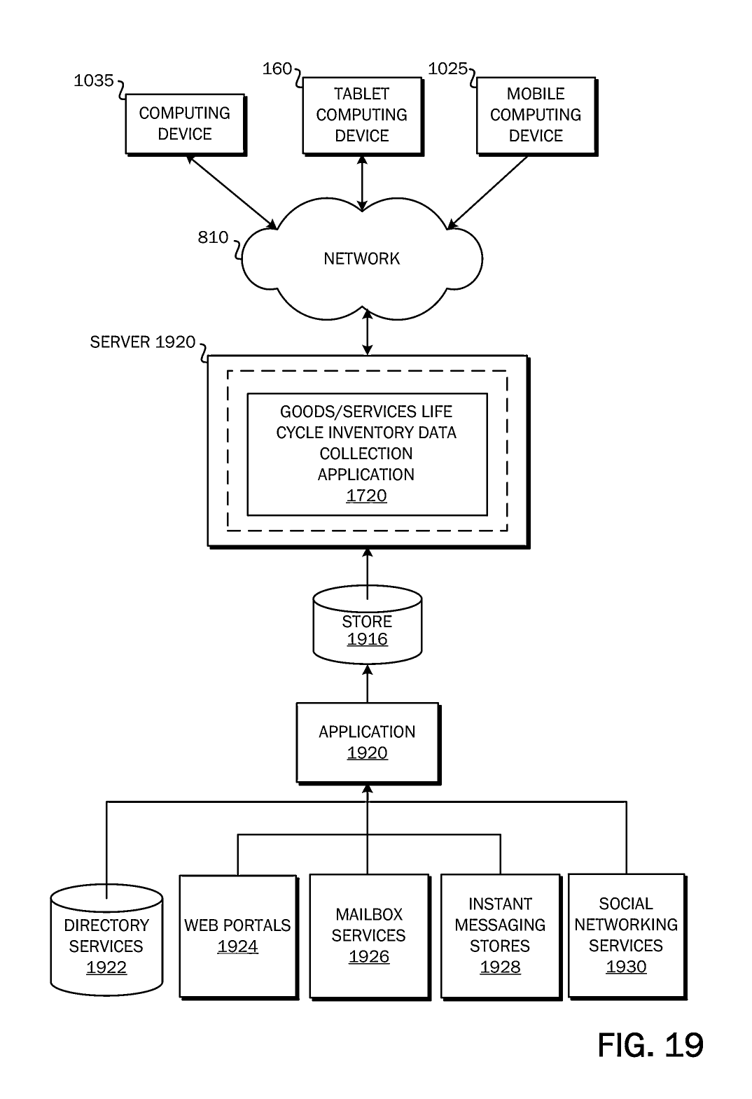

FIG. 19 illustrates a system architecture for providing life cycle inventory and assessment data to one or more client devices, as described above. Content developed, interacted with or edited in association with a life cycle inventory and assessment application 1720 may be stored in different communication channels or other storage types. For example, various LCI and LCIA items along with information from which they are developed may be stored using directory services 1922, web portals 1924, mailbox services 1926, instant messaging stores 1928 and social networking sites 1930. The life cycle inventory and assessment application 1720 may use any of these types of systems or the like for enabling data utilization, as described herein. A server 1920 may provide life cycle inventory and assessment data to clients. As one example, server 1920 may be a web server providing life cycle inventory and assessment data over the web. Server 1920 may provide life cycle inventory and assessment data over the web to clients through a network 1915. Examples of clients that may obtain content visualizations include computing device 1700, which may include any general purpose personal computer, a tablet computing device 160, 815, 830 and/or mobile computing device 1025 which may include smart phones. Any of these devices may obtain content from the store 1916.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

1. A method of obtaining life cycle data for a product from a life cycle inventory and assessment system, comprising:
presenting a life cycle assessment interface in a computer-generated display;
providing in the life cycle assessment interface a first field for receiving a request for life cycle data for the product;
receiving in the first field identification information for the product for receiving life cycle data for the product;
parsing the identification information for one or more metadata items associated with the product;
searching a data store of life cycle data for one or more life cycle data items associated with the one or more metadata items; and
retrieving the one or more life cycle data items associated with the one or more metadata items in response to the identification information for the product for receiving life cycle data for the product.

2. The method of claim 1, further comprising displaying in the life cycle assessment interface the retrieved one or more life cycle data items associated with the one or more metadata items in response to the identification information for the product for receiving life cycle data for the product.

3. The method of claim 2, wherein displaying in the life cycle assessment interface the retrieved one or more life cycle data items includes displaying one or more validated life cycle inventory data items for the product.

4. The method of claim 2, wherein displaying in the life cycle assessment interface the retrieved one or more life cycle data items includes displaying one or more validated life cycle impact assessments for one or more components of the product.

5. The method of claim 1, wherein presenting the life cycle assessment interface in the computer-generated display includes presenting the life cycle assessment interface in the computer-generated display operatively connected to the life cycle inventory and assessment system via a web interface.

6. The method of claim 5, wherein presenting the life cycle assessment interface in the computer-generated display includes displaying the life cycle assessment interface in a kiosk operative to provide life cycle data for one or more products via the web interface.

7. The method of claim 1, wherein prior to presenting the life cycle assessment interface in a computer-generated display, authenticating access privileges of a requester of life cycle data for the product.

8. The method of claim 7, wherein retrieving the one or more life cycle data items associated with the one or more metadata items in response to the identification information for the product for receiving life cycle data for the product includes retrieving only those one or more life cycle data items accessible by the requester of life cycle data for the product based on an access privilege assigned to the requester.

9. The method of claim 1, wherein receiving in the first field identification information for the product for receiving life cycle data for the product includes receiving in the first field a structured data item for the product, the structured data item having the one or more metadata items that may be used for obtaining life cycle data associated with the product.

10-20. (canceled)

21. A computer readable storage medium containing computer executable instructions which when executed by a computer perform a method of obtaining life cycle data for a product from a life cycle inventory and assessment system, the method comprising:
presenting a life cycle assessment interface in a computer-generated display;
providing in the life cycle assessment interface a first field for receiving a request for life cycle data for the product;
receiving in the first field identification information for the product for receiving life cycle data for the product;
parsing the identification information for one or more metadata items associated with the product;
searching a data store of life cycle data for one or more life cycle data items associated with the one or more metadata items; and
retrieving the one or more life cycle data items associated with the one or more metadata items in response to the identification information for the product for receiving life cycle data for the product.

22. The computer readable storage medium of claim 21, further comprising displaying in the life cycle assessment interface the retrieved one or more life cycle data items associated with the one or more metadata items in response to the identification information for the product for receiving life cycle data for the product.

23. The computer readable storage medium of claim 21, wherein presenting the life cycle assessment interface in the computer-generated display includes presenting the life cycle assessment interface in the computer-generated display operatively connected to the life cycle inventory and assessment system via a web interface.

24. The computer readable storage medium of claim 23, wherein presenting the life cycle assessment interface in the computer-generated display includes displaying the life cycle assessment interface in a kiosk operative to provide life cycle data for one or more products via the web interface.

25. The computer readable storage medium of claim 21, wherein receiving in the first field identification information for the product for receiving life cycle data for the product includes receiving in the first field a structured data item for the product, the structured data item having the one or more metadata items that may be used for obtaining life cycle data associated with the product.

26. A system for obtaining life cycle data for a product from a life cycle inventory and assessment system, comprising:
a processor; and
a memory connected to the processor, the memory including instructions that, when executed by the processor, cause the processor to instantiate a query-based hold module configured to:
present a life cycle assessment interface in a computer-generated display;
provide in the life cycle assessment interface a first field for receiving a request for life cycle data for the product;
receive in the first field identification information for the product for receiving life cycle data for the product;
parse the identification information for one or more metadata items associated with the product;
search a data store of life cycle data for one or more life cycle data items associated with the one or more metadata items; and
retrieve the one or more life cycle data items associated with the one or more metadata items in response to the identification information for the product for receiving life cycle data for the product.

27. The system of claim 26, further comprising displaying in the life cycle assessment interface the retrieved one or more life cycle data items associated with the one or more metadata items in response to the identification information for the product for receiving life cycle data for the product.

28. The system of claim 26, wherein presenting the life cycle assessment interface in the computer-generated display includes presenting the life cycle assessment interface in the computer-generated display operatively connected to the life cycle inventory and assessment system via a web interface.

29. The system of claim 28, wherein presenting the life cycle assessment interface in the computer-generated display includes displaying the life cycle assessment interface in a kiosk operative to provide life cycle data for one or more products via the web interface.

30. The system of claim 26, wherein receiving in the first field identification information for the product for receiving life cycle data for the product includes receiving in the first field a structured data item for the product, the structured data item having the one or more metadata items that may be used for obtaining life cycle data associated with the product.

31. The system of claim 26, wherein receiving in the first field identification information for the product for receiving life cycle data for the product includes receiving in the first field a structured data item for the product, the structured data item having the one or more metadata items that may be used for obtaining life cycle data associated with the product.
